(19) United States
(12) Patent Application Publication
(10) Pub. No.: US 2026/0006534 A1
(43) Pub. Date: Jan. 1, 2026

(54) TECHNIQUES FOR EFFICIENT MASTER INFORMATION BLOCK AND PHYSICAL CELL IDENTITY SIGNALING

(71) Applicant: QUALCOMM Incorporated, San Diego, CA (US)

(72) Inventors: Ahmed BEDEWY, Hillsborough, NJ (US); Naeem AKL, BRIDGEWATER, NJ (US); Navid ABEDINI, Basking Ridge, NJ (US); Karl Georg HAMPEL, Jersey City, NJ (US); Qing LI, PRINCETON JUNCTION, NJ (US); Junyi LI, Greentown, PA (US)

(21) Appl. No.: 18/759,377

(22) Filed: Jun. 28, 2024

(51) Int. Cl. H04W 48/08

(52) U.S. Cl. CPC H04W 48/08

(57) ABSTRACT

Methods, systems, and devices for wireless communications are described. A network entity may obtain (from another network entity or from a higher layer) a control message that indicates a content configuration for a master information block (MIB) message, a physical cell identity (PCI), or both. In some aspects, the content configuration may indicate a type of information to be specified by one or more wildcard bits of the MIB, the PCI, or both, such as operator-specific information or other system information. The network entity may output the MIB, the PCI, or both, including the one or more wildcard bits indicating the type of information. The network entity may then communicate with a user equipment (UE) in accordance with the type of information indicated by the one or more wildcard bits of the MIB, the PCI, or both.

### FIELD OF TECHNOLOGY

The following relates to wireless communications, including techniques for efficient master information block (MIB) and physical cell identity (PCI) signaling.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a network entity is described. The method may include obtaining a control message indicative of a content configuration for a master information block (MIB) message, a physical cell identity (PCI), or both, where the content configuration includes an indication of a type of information to be specified by one or more wildcard bits of the MIB message, the PCI, or both, outputting the MIB message, the PCI, or both, including the one or more wildcard bits indicating the type of information, and communicating with a user equipment (UE) in accordance with the type of information indicated by the one or more wildcard bits of the MIB message, the PCI, or both.

A network entity for wireless communications is described. The network entity may include one or more memories storing processor executable code, and one or more processors coupled with the one or more memories. The one or more processors may individually or collectively be operable to execute the code to cause the network entity to obtain a control message indicative of a content configuration for a MIB message, a PCI, or both, where the content configuration includes an indication of a type of information to be specified by one or more wildcard bits of the MIB message, the PCI, or both, output the MIB message, the PCI, or both, including the one or more wildcard bits indicating the type of information, and communicate with a UE in accordance with the type of information indicated by the one or more wildcard bits of the MIB message, the PCI, or both.

Another network entity for wireless communications is described. The network entity may include means for obtaining a control message indicative of a content configuration for a MIB message, a PCI, or both, where the content configuration includes an indication of a type of information to be specified by one or more wildcard bits of the MIB message, the PCI, or both, means for outputting the MIB message, the PCI, or both, including the one or more wildcard bits indicating the type of information, and means for communicating with a UE in accordance with the type of information indicated by the one or more wildcard bits of the MIB message, the PCI, or both.

A non-transitory computer-readable medium storing code for wireless communications is described. The code may include instructions executable by one or more processors to obtain a control message indicative of a content configuration for a MIB message, a PCI, or both, where the content configuration includes an indication of a type of information to be specified by one or more wildcard bits of the MIB message, the PCI, or both, output the MIB message, the PCI, or both, including the one or more wildcard bits indicating the type of information, and communicate with a UE in accordance with the type of information indicated by the one or more wildcard bits of the MIB message, the PCI, or both.

In some examples of the method, network entities, and non-transitory computer-readable medium described herein, the type of information specified by the one or more wildcard bits of the MIB message, the PCI, or both, may be based on an operator associated with the network entity, a geo-location of the network entity, a cell of the network entity, or any combination thereof.

In some examples of the method, network entities, and non-transitory computer-readable medium described herein, obtaining the control message indicative of the content configuration for the MIB message, the PCI, or both may include operations, features, means, or instructions for obtaining an indication of a location reserved for the one or more wildcard bits in the MIB message, the PCI, or both.

In some examples of the method, network entities, and non-transitory computer-readable medium described herein, outputting the MIB message, the PCI, or both may include operations, features, means, or instructions for outputting the MIB message, the PCI, or both, where at least one wildcard bit of the one or more wildcard bits may be indicative of a mobile cell associated with the network entity, a stationary cell associated with the network entity, one or more network energy saving configurations associated with the network entity, a capability to support reduced capability UEs, one or more information elements of a system information block (SIB), or any combination thereof.

Some examples of the method, network entities, and non-transitory computer-readable medium described herein may further include operations, features, means, or instructions for outputting an indication of a communication configuration associated with the UE, where an application of the communication configuration may be based on an application indication included in the one or more wildcard bits.

In some examples of the method, network entities, and non-transitory computer-readable medium described herein, outputting the MIB message, the PCI, or both may include operations, features, means, or instructions for outputting an indication that a quantity of the one or more wildcard bits include fixed bits indicative of whether the one or more wildcard bits may be activated or deactivated.

In some examples of the method, network entities, and non-transitory computer-readable medium described herein, obtaining the control message indicative of the content configuration for the MIB message may include operations, features, means, or instructions for obtaining an indication that at least a subset of wildcard bits of the one or more wildcard bits may be changed from wildcard bits to one or more standardized information elements of the MIB message.

Some examples of the method, network entities, and non-transitory computer-readable medium described herein may further include operations, features, means, or instructions for outputting, to the UE, an indication of an interpretation of the type of information of the one or more wildcard bits, where the control message includes a dynamically signaled message, a radio resource control (RRC) message, a policy message, a SIB message, dedicated signaling, an information message that indicate the type of information stored in a cloud environment, or any combination thereof.

In some examples of the method, network entities, and non-transitory computer-readable medium described herein, the control message indicative of the content configuration for the MIB message, the PCI, or both, includes an indication of a validity duration for the type of information specified by the one or more wildcard bits.

Some examples of the method, network entities, and non-transitory computer-readable medium described herein may further include operations, features, means, or instructions for receiving, from the UE, a measurement report indicative of an interpretation of the one or more wildcard bits by the UE.

In some examples of the method, network entities, and non-transitory computer-readable medium described herein, the one or more wildcard bits included in the PCI include one or more most significant bits or one or more least significant bits, and may be indicative of a functionality or a characteristic of a cell associated with the network entity.

In some examples of the method, network entities, and non-transitory computer-readable medium described herein, obtaining the control message indicative of the content configuration for the PCI may include operations, features, means, or instructions for obtaining the control message including an indication of a location of the one or more wildcard bits within a bitstring of the PCI, where the one or more wildcard bits indicate system information.

In some examples of the method, network entities, and non-transitory computer-readable medium described herein, obtaining the control message indicative of the content configuration for the MIB message, the PCI, or both, may include operations, features, means, or instructions for obtaining the control message via signaling between one or more network interfaces associated with the network entity, the one or more network interfaces comprising a centralized unit to distributed unit F1 interface, a centralized unit to centralized unit Xn interface, a core network interface, or any combination thereof.

In some examples of the method, network entities, and non-transitory computer-readable medium described herein, the type of information includes system information that may be indicated at least in part by the PCI, a physical broadcast channel, the MIB message, one or more demodulation reference signals (DMRSs), or any combination thereof.

In some examples of the method, network entities, and non-transitory computer-readable medium described herein, outputting the MIB message, the PCI, or both may include operations, features, means, or instructions for outputting the MIB message, the PCI, or both, including an indication of system information for initial access to a cell associated with the network entity.

A method for wireless communications by a UE is described. The method may include receiving a control message indicative of a content configuration for a MIB message, a PCI, or both, where the content configuration includes an indication of a type of information specified by one or more wildcard bits of the MIB message, the PCI, or both, receiving the MIB message, the PCI, or both, including one or more wildcard bits, and communicating with a network entity in accordance with the type of information indicated by the one or more wildcard bits of the MIB message, the PCI, or both.

A UE for wireless communications is described. The UE may include one or more memories storing processor executable code, and one or more processors coupled with the one or more memories. The one or more processors may individually or collectively be operable to execute the code to cause the UE to receive a control message indicative of a content configuration for a MIB message, a PCI, or both, where the content configuration includes an indication of a type of information specified by one or more wildcard bits of the MIB message, the PCI, or both, receive the MIB message, the PCI, or both, including one or more wildcard bits, and communicate with a network entity in accordance with the type of information indicated by the one or more wildcard bits of the MIB message, the PCI, or both.

Another UE for wireless communications is described. The UE may include means for receiving a control message indicative of a content configuration for a MIB message, a PCI, or both, where the content configuration includes an indication of a type of information specified by one or more wildcard bits of the MIB message, the PCI, or both, means for receiving the MIB message, the PCI, or both, including one or more wildcard bits, and means for communicating with a network entity in accordance with the type of information indicated by the one or more wildcard bits of the MIB message, the PCI, or both.

A non-transitory computer-readable medium storing code for wireless communications is described. The code may include instructions executable by one or more processors to receive a control message indicative of a content configuration for a MIB message, a PCI, or both, where the content configuration includes an indication of a type of information specified by one or more wildcard bits of the MIB message, the PCI, or both, receive the MIB message, the PCI, or both, including one or more wildcard bits, and communicate with a network entity in accordance with the type of information indicated by the one or more wildcard bits of the MIB message, the PCI, or both.

In some examples of the method, UEs, and non-transitory computer-readable medium described herein, receiving the control message indicative of the content configuration for the MIB message, the PCI, or both may include operations, features, means, or instructions for receiving an indication of a location reserved for the one or more wildcard bits in the MIB message, the PCI, or both.

In some examples of the method, UEs, and non-transitory computer-readable medium described herein, receiving the MIB message, the PCI, or both may include operations, features, means, or instructions for receiving the MIB message, the PCI, or both, where at least one wildcard bit of the one or more wildcard bits may be indicative of a mobile cell associated with the network entity, a stationary cell associated with the network entity, one or more network energy saving configurations associated with the network entity, a capability to support reduced capability UEs, one or more information elements of a SIB, or any combination thereof.

Some examples of the method, UEs, and non-transitory computer-readable medium described herein may further include operations, features, means, or instructions for receiving an indication of a communication configuration associated with the UE, where an application of the communication configuration may be based on an application indication included in the one or more wildcard bits.

In some examples of the method, UEs, and non-transitory computer-readable medium described herein, receiving the MIB message, the PCI, or both may include operations, features, means, or instructions for receiving an indication that a quantity of the one or more wildcard bits include fixed bits indicative of whether the one or more wildcard bits may be activated or deactivated.

Some examples of the method, UEs, and non-transitory computer-readable medium described herein may further include operations, features, means, or instructions for receiving an indication of an interpretation of the type of information of the one or more wildcard bits, where the control message includes a dynamically signaled message, a RRC message, a policy message, a SIB message, dedicated signaling, an information message that indicate the type of information stored in a cloud environment, or any combination thereof.

In some examples of the method, UEs, and non-transitory computer-readable medium described herein, the control message indicative of the content configuration for the MIB message, the PCI, or both, includes an indication of a validity duration for the type of information specified by the one or more wildcard bits.

Some examples of the method, UEs, and non-transitory computer-readable medium described herein may further include operations, features, means, or instructions for transmitting a measurement report indicative of an interpretation of the one or more wildcard bits by the UE.

In some examples of the method, UEs, and non-transitory computer-readable medium described herein, the one or more wildcard bits included in the PCI include one or more most significant bits or one or more least significant bits, and may be indicative of a functionality or a characteristic of a cell associated with the network entity.

In some examples of the method, UEs, and non-transitory computer-readable medium described herein, receiving the control message indicative of the content configuration for the PCI may include operations, features, means, or instructions for receiving the control message including an indication of a location of the one or more wildcard bits within a bitstring of the PCI, where the one or more wildcard bits indicate system information.

Some examples of the method, UEs, and non-transitory computer-readable medium described herein may further include operations, features, means, or instructions for determining a structure of the PCI including the location of the one or more wildcard bits within the bitstring of the PCI based on the structure of the PCI received during a previous connection with the network entity, based on the structure of other physical cell identities received during communication with one or more other network entities, or both.

Some examples of the method, UEs, and non-transitory computer-readable medium described herein may further include operations, features, means, or instructions for determining a structure of the PCI including the location of the one or more wildcard bits within the bitstring of the PCI based on hard coded information at the UE.

In some examples of the method, UEs, and non-transitory computer-readable medium described herein, the type of information includes system information that may be indicated at least in part by the PCI, a physical broadcast channel, the MIB message, one or more DMRSs, or any combination thereof.

In some examples of the method, UEs, and non-transitory computer-readable medium described herein, receiving the MIB message, the PCI, or both may include operations, features, means, or instructions for receiving the MIB message, the PCI, or both, including an indication of system information for initial access to a cell associated with the network entity and performing an initial access procedure based on the indication of system information.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows an example of a wireless communications system that supports techniques for efficient master information block (MIB) and physical cell identity (PCI) signaling in accordance with one or more aspects of the present disclosure.

FIG. 2 shows an example of a network architecture that supports techniques for efficient MIB and PCI signaling in accordance with one or more aspects of the present disclosure.

FIGS. 3, 4, 5 show examples of wireless communications systems that support techniques for efficient MIB and PCI signaling in accordance with one or more aspects of the present disclosure.

FIG. 6 shows example cell search procedures that support techniques for efficient MIB and PCI signaling in accordance with one or more aspects of the present disclosure.

FIG. 7 shows an example of a process flow that supports techniques for efficient MIB and PCI signaling in accordance with one or more aspects of the present disclosure.

FIGS. 8 and 9 show block diagrams of devices that support techniques for efficient MIB and PCI signaling in accordance with one or more aspects of the present disclosure.

FIG. 10 shows a block diagram of a communications manager that supports techniques for efficient MIB and PCI signaling in accordance with one or more aspects of the present disclosure.

FIG. 11 shows a diagram of a system including a device that supports techniques for efficient MIB and PCI signaling in accordance with one or more aspects of the present disclosure.

FIGS. 12 and 13 show block diagrams of devices that support techniques for efficient MIB and PCI signaling in accordance with one or more aspects of the present disclosure.

FIG. 14 shows a block diagram of a communications manager that supports techniques for efficient MIB and PCI signaling in accordance with one or more aspects of the present disclosure.

FIG. 15 shows a diagram of a system including a device that supports techniques for efficient MIB and PCI signaling in accordance with one or more aspects of the present disclosure.

FIGS. 16 and 17 show flowcharts illustrating methods that support techniques for efficient MIB and PCI signaling in accordance with one or more aspects of the present disclosure.

### DETAILED DESCRIPTION

A user equipment (UE) may perform a cell search procedure to acquire time and frequency synchronization with a cell served by a network entity, and to detect a physical layer cell identifier (PCI) information for the cell. For example, during cell search operations, the UE may receive one or more synchronization signals and a physical broadcast channel (PBCH), which may include information that the UE may use to access (e.g., connect with, perform communications with) the cell. In some examples, the UE may receive a PBCH block, and may decode the PBCH to obtain system information including a master information block (MIB), which carries essential system information that the UE may use to establish an initial connection with the cell and to perform ongoing communications.

In some aspects, the MIB may include a payload of information bits (e.g., 24 total MIB bits), which may be limited or specified. For example, the MIB payload may include a set of information elements which include specified system information, along with a set of reserved bits, which the UE may use to perform initial cell selection. In addition to the MIB, the UE may receive a PCI, which is a multi-bit (e.g., 24-bit) indicator that represents the physical layer identifier of a specific cell served by a network entity. In some aspects, the UE may use the PCI for cell synchronization, cell identification, and information scrambling (or identifying scrambled information), allowing the UE to accurately identify and select the cell.

The UE may use both the MIB and the PCI (among other system information) to identify and communicate with the network entity and a cell associated with the network entity. The total payload (e.g., the total quantity of bits) allowed in both the MIB and PCI, however, may be finite (e.g., limited). For example, the MIB may include bits of essential system information within a relatively limited quantity of bits (e.g., 24 bits), with most of the information being pre-defined (or otherwise specification-defined). In some cases, however, the MIB may have a format that includes a quantity of reserved bits that may have undefined content (e.g., content that is not explicitly defined by a specification). In addition, while the PCI may include important cell identification information (e.g., cell identity) and may be used for physical procedures and local cell identification purposes, the structure of the PCI beyond the cell identification information may be undefined.

In some implementations, the network entity may modify (e.g., dynamically) the MIB, the PCI, or both, in order to increase the efficiency of information signaling through the MIB and the PCI, and to enhance the cell search procedure for the UE. For example, the network entity may identify wildcard bits in the MIB (or specified bits in the PCI), which may be used or defined to convey different types of information. For example, the network entity may configure the wildcard bits may convey different types of operator-specific content, or any other additional system information that may be of use for the UE. For example, the wildcard bits may be used to classify mobile cells or stationary cells, the wildcard bits may be used to indicate various ways in which the serving cell performs network energy savings, or the wildcard bits may be used to indicate whether the cell supports reduced capability (RedCap) UEs. Similarly, the network entity may use additional bits in the PCI to indicate different system information.

Aspects of the disclosure may be implemented to realize one or more possible advantages. For example, the re-use or specification of wildcard bits in both the MIB and PCI may allow for improved cell access performance since the UE may obtain cell-specific system information prior to performing a full initial access procedure, which may allow the UE to determine whether or not to connect to a cell. Additionally, or alternatively, the specification of wildcard bits in both the MIB and PCI may allow for reduced communication overhead since additional signaling of system information can be eliminated (and instead included in the wildcard bits of the MIB or the PCI). Additionally, or alternatively, the specification of wildcard bits in both the MIB and PCI may allow for increased network and UE power savings, since erroneous or failed cell search and initial access procedures may be reduced due to additional information available in the MIB and PCI.

Aspects of the disclosure are initially described in the context of wireless communications systems. Aspects of the disclosure are further illustrated by and described with reference to cell search procedures, a process flow, apparatus diagrams, system diagrams, and flowcharts that relate to techniques for efficient MIB and PCI signaling.

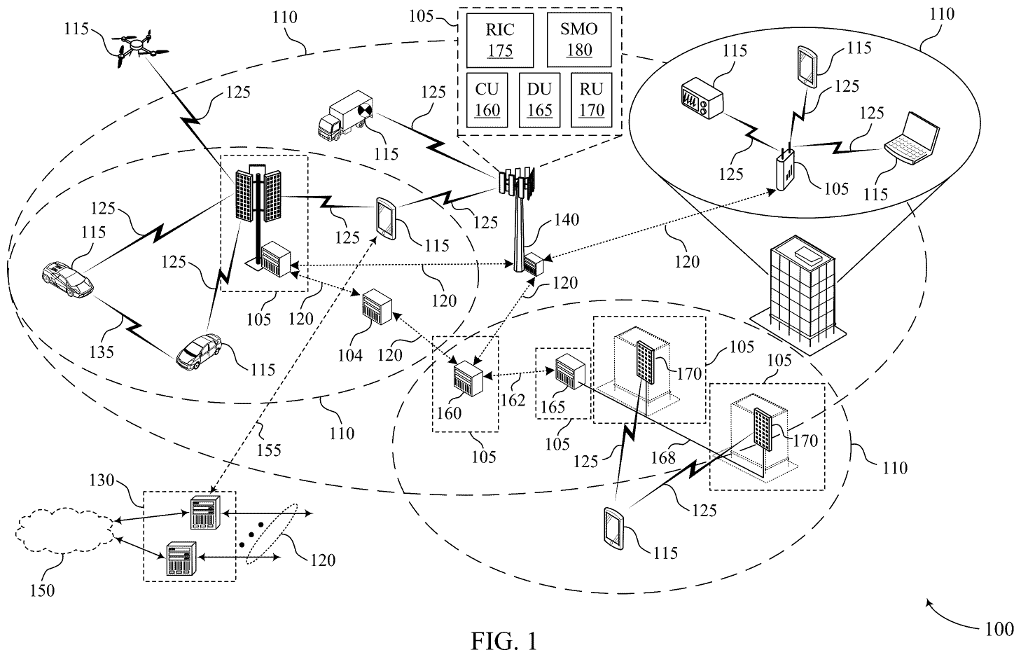

FIG. 1 shows an example of a wireless communications system 100 that supports techniques for efficient MIB and PCI signaling in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A UE 115 may perform a cell search procedure to acquire time and frequency synchronization with a cell served by a network entity 105. For example, during cell search operations, the UE 115 may receive one or more synchronization signals and a PBCH, which may include information that the UE 115 may use to access the cell served by the network entity 105. In some examples, the UE 115 may receive a PBCH block, and may decode the PBCH to obtain system information including a MIB which carries essential system information that the UE 115 may use to establish an initial connection with the cell and to perform ongoing communications. In addition to the MIB, the UE 115 may receive a PCI, which is a multi-bit (e.g., 24-bit) indicator that represents the physical layer identifier of a specific cell served by a network entity.

The UE 115 may use both the MIB and the PCI (among other system information) to identify and communicate with the network entity and a cell associated with the network entity 105. The total payload (e.g., the total quantity of bits) allowed in both the MIB and PCI, however, may be finite (e.g., limited). For example, the MIB may include bits of essential system information within a relatively limited quantity of bits (e.g., 24 bits), with most of the information being pre-defined (or otherwise specification-defined). In some cases, however, the MIB may have a format that includes a quantity of reserved bits that may have undefined content (e.g., content that is not explicitly defined by a specification). In addition, while the PCI may include important cell identification information (e.g., cell identity) and may be used for physical procedures and local cell identification purposes, the structure of the PCI beyond the cell identification information may be undefined.

In some implementations, the network entity 105 may modify the MIB, the PCI, or both, in order to increase the efficiency of information signaling through the MIB and the PCI, and to enhance the cell search procedure for the UE 115. For example, the network entity 105 may identify wildcard bits in the MIB (or specified bits in the PCI), which may be used or defined to convey different types of information. For example, the network entity 105 may configure the wildcard bits may convey different types of operator-specific content, or any other additional system information that may be of use for the UE 115. Similarly, the network entity 105 may use additional bits in the PCI to indicate different system information.

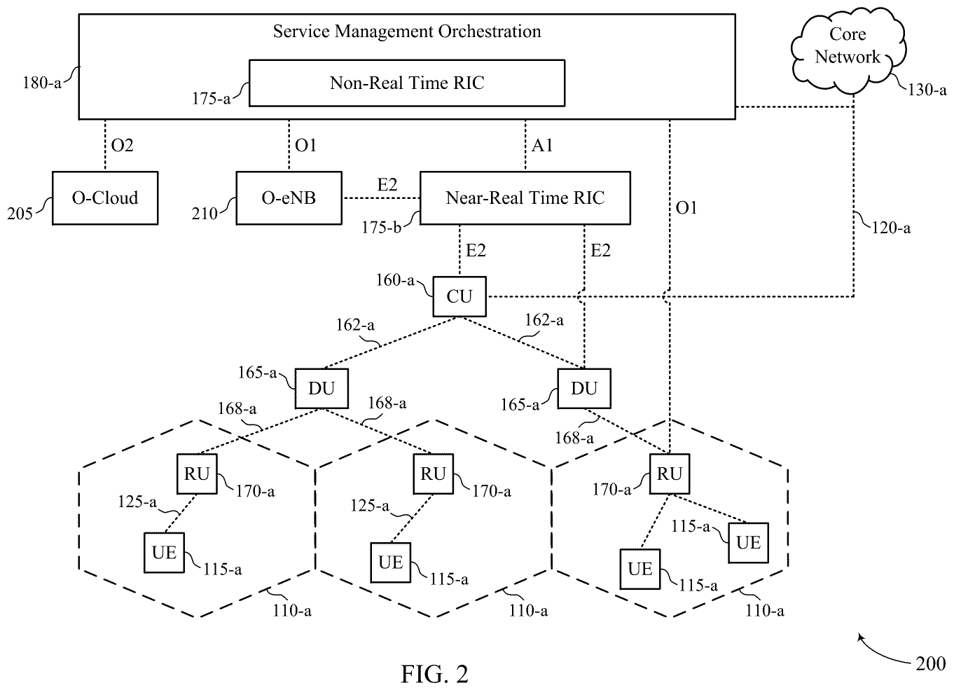

FIG. 2 shows an example of a network architecture 200 (e.g., a disaggregated base station architecture, a disaggregated RAN architecture) that supports techniques for efficient MIB and PCI signaling in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

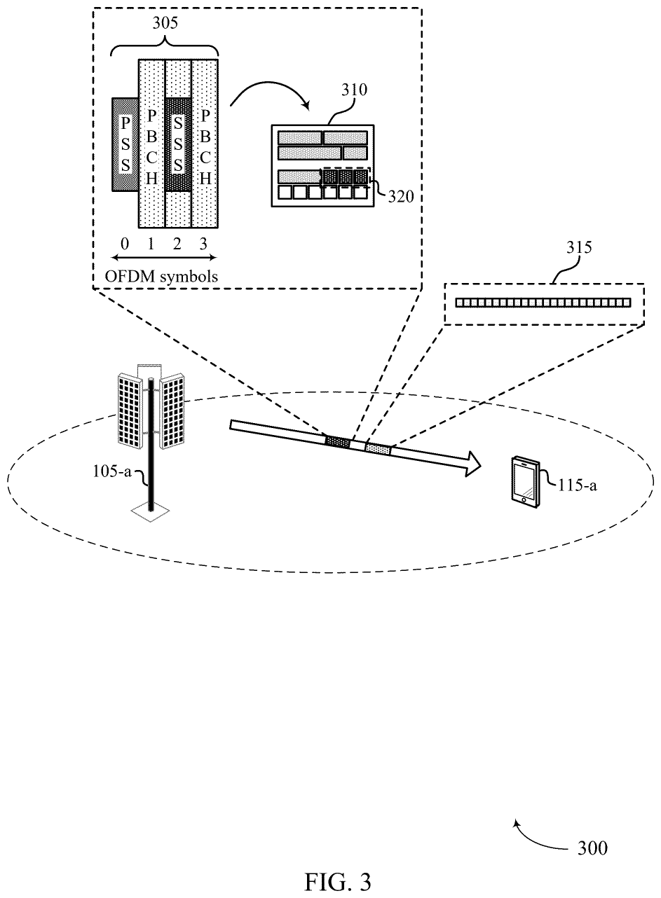

FIG. 3 shows an example of a wireless communications system 300 that supports techniques for efficient MIB and PCI signaling in accordance with one or more aspects of the present disclosure. For example, the wireless communications system 300 illustrates signaling between a UE 115-a and a network entity 105-a, each of which may be an example of corresponding UEs 115 and network entities 105 described herein.

The UE 115-a may perform a cell search procedure to acquire time and frequency synchronization with a cell served by the network entity 105-a, and to detect a physical layer cell identifier (PCI) information of the cell. For example, during cell search operations, the UE 115-a may receive one or more synchronization signals and a physical broadcast channel (PBCH), which may include information that the UE 115-a may use to access (e.g., connect with, perform communications with) the cell. In some examples, the UE 115-a may receive a PBCH block or synchronization signal block (SSB), such as SSB 305, which includes the PBCH and two types of synchronization signals, including a primary synchronization signal (PSS) and a secondary synchronization signal (SSS). In some aspects, the UE 115-a may decode (e.g., extract information from) the PBCH to obtain system information within the SSB 305 (e.g., a SS-PBCH block beam), including a MIB 310.

In some aspects, the UE 115-a may decode the MIB 310 in order to obtain other system information transmitted on the PDSCH. For example, the MIB 310 may include important (e.g., mandatory, essential) system information that the UE 115-a uses to access the cell and perform ongoing communications. In some implementations, the network entity 105-a may transmit (e.g., broadcast) the MIB 310 to the UE 115-a using a set periodicity. During initial cell selection, the network entity 105-a may broadcast the MIB 310 to the UE 115-a via the SSB 305 every 20 milliseconds (or using another set periodicity), and the UE 115-a may assume that the network entity 105-a transmits the MIB 310 over OFDM symbols 0, 1, 2, and 3, according to the set periodicity.

In some implementations, the MIB 310 may include a payload of information bits (e.g., 24 total MIB bits), which may be limited or specified. In some examples, the MIB 310 may have a MIB format which specifies a quantity of reserved bits. For example, MIB payload may include system frame number information (e.g., systemFrameNumber) which includes a 10 bit system frame number ranging from 0 to 1023, and corresponding to 10.24 seconds. The MIB payload may also include subcarrier spacing information (e.g., subCarrierSpacingCommon), which includes subcarrier spacing details for various communication purposes, including the subcarrier spacing for receiving system information (e.g., system information block-1 (SIB1)). The MIB payload may also include a physical downlink control channel (PDCCH) configuration for receiving SIB1 (e.g., pdcch-ConfigSIB1), which may determine a common control resource set (CORESET), a common search space, and other PDCCH parameters for receiving the SIB1. For example, if SIB1 is present, the configuration may indicate the frequency positions in which the UE 115-a may find synchronization signal or PBCH blocks that include the SIB1. The MIB payload may also include various demodulation reference signal (DMRS) position information, barred cell information, and intra frequency cell reselection information. The UE 115-a may use the information in the MIB 310 (and the SIB1) as minimum system information for the UE 115-a to perform initial cell selection.

In addition to the MIB 310, the UE 115-a may receive a PCI 315, which is a multi-bit (e.g., 24-bit) indicator that represents the physical layer identifier of a specific cell served by a network entity 105-a. In some aspects, the PSS may support 366 SSS values (per PSS) with 3 PSS values, which may allow for 1008 possible PCI values (e.g., the PCI 315 may be calculated by multiplying the total number of SSS values by the number of PSS values). In some aspects, the UE 115-a may use the PCI for cell synchronization, cell identification, information scrambling (or identifying scrambled information), and reduces the likelihood that the UE 115-a connects to the wrong cell, or that unauthorized users gain access to the cell.

The UE 115-a may use both the MIB 310 and the PCI 315 (among other system information) to identify and communicate with the network entity 105-a. The total payload (e.g., the total quantity of bits) allowed in both the MIB 310 and PCI 315, however, may be finite (e.g., limited). For example, the MIB 310 may include bits of essential system information within a relatively limited quantity of bits (e.g., 24 bits), and most of the information is pre-defined (or otherwise specification-defined). In some cases, the MIB 310 may have a format that includes a quantity of reserved bits that may have undefined content (e.g., content that is not explicitly defined by a specification). In addition, while the PCI 315 may include important cell identification information (e.g., cell identity) and may be used for physical procedures and local cell identification purposes, the structure of the PCI 315 beyond the cell identification information may be undefined.

In some implementations, the network entity 105-a may modify (e.g., dynamically) the MIB 310, the PCI 315, or both, in order to increase the efficiency of information signaling through the MIB 310 and the PCI 315, and to enhance the cell search procedure for the UE 115-a. For example, the network entity 105-a may identify wildcard bits 320 in the MIB 310 (or specified bits in the PCI 315), which may be used or defined to convey different types of information. For example, the network entity 105-a may configure the wildcard bits 320 may convey different types of operator-specific content, or any other additional information that may be of use for the UE 115-a. For example, the wildcard bits 320 may be used to classify a cell as being a mobile cell or a stationary cell, the wildcard bits 320 may be used to indicate various ways in which the serving cell performs network energy savings, or the wildcard bits 320 may be used to indicate whether the cell supports RedCap UEs.

In some implementations, the network entity 105-a may receive an indication of the different content to be included in the MIB 310 or different content for the PCI 315 via other network entities, from higher layer signaling, or from signaling between different network interfaces. For example, the network entity 105-a may support signaling between CU and DU components (e.g., over an F1 interface), where the CU may indicate or signal, to the DU, one or more rules or other information regarding how the DU is to select MIB content or PCI content for cells served by the DU. In some aspects, the DU may select the MIB content or the PCI content based on supported features of the UE 115-a, based on functionalities of the network entity 105-a, or both. Additionally or alternatively, the CU may indicate or signal, to the DU, one or more rules, features, or other supported functionalities of other cells that the DU may use to determine the content of the MIB or the PCI. In some other examples, the network entity 105-a may support signaling between CU and CU components (e.g., via an Xn interface), where a first CU may share, with a second CU, information regarding how MIB content and PCI content is configured for cells associated with the network entity 105-a, or for other cells (e.g., neighboring cells). In some other implementations, the network entity 105-a may receive one or more rules or other information regarding the content of the MIB 310 and PCI 315 via a service or function in the core network.

In some examples, the wildcard bits 320 may be flexibly configured, and may change content based on one or more location-specific factors, one or more cell-specific factors, based on one or more operator-specific factors, or any combination thereof. The implementation of specified bits may also be extended to bits included in the PCI 315, so that different bit strings included in the PCI 315 may indicate different operator-specific content. The re-use of bits in both the MIB 310 and PCI 315 may allow for improved cell access performance, reduced communication overhead, and more efficient usage of information bits in system information signaling.

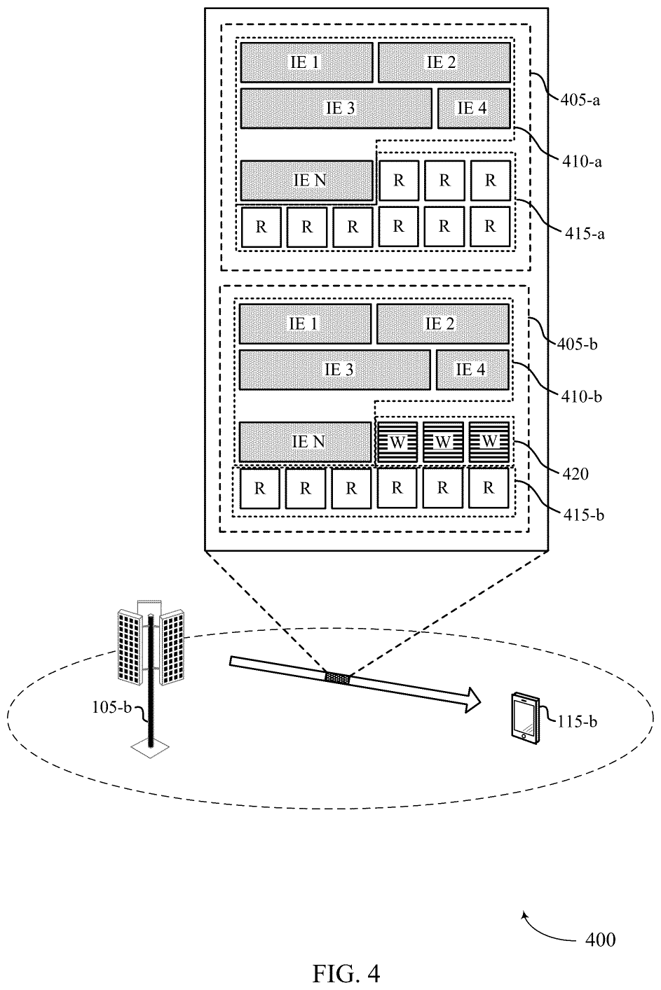

FIG. 4 shows an example of a wireless communications system 400 that supports techniques for efficient MIB and PCI signaling in accordance with one or more aspects of the present disclosure. For example, the wireless communications system 400 illustrates signaling between a UE 115-b and a network entity 105-b, each of which may be an example of corresponding UEs 115 and network entities 105 described herein.

The network entity 105-b may transmit (e.g., output, broadcast) system information to the UE 115-b, including one or more synchronization signals (e.g., SSBs) including a PBCH, which may include information that the UE 115-b may use to access the cell served by the network entity 105-b. In some examples, the UE 115-b may receive the one or more SSBs, and may decode (e.g., extract information from) the PBCH to obtain the system information within the SSB including a MIB (e.g., MIB 405-a or MIB 405-b).

In some aspects, the received MIB may have one or more different structures. For example, a MIB 405-a may have a first quantity of information elements 410-a (e.g., IE 1, IE 2, IE 3, IE 4, through IE N), which may include specified or set system information (e.g., system frame number, subcarrier spacing, DMRS information, PDCCH configuration information), and a set of reserved bits 415-a or reserved fields that may be specified for information (or may be left unspecified). A MIB 405-b may have a quantity of information elements 410-b (e.g., IE 1, IE 2, IE 3, IE 4, through IE N), which also may include the specified or set system information (e.g., system frame number, subcarrier spacing, DMRS information, PDCCH configuration information), along with a quantity of reserved bits 415-b. In some implementations, the MIB 405-b may also include wildcard bits 420 (or wildcard information fields) which may include various different types of information that may be specified or configured by the network entity 105-b (or by other network entities or a higher layer). For example, the location of the wildcard bits 420 in the MIB, the quantity of the wildcard bits 420, or both, may be specified, but the information included in the wildcard bits 420 may be operator-specific. In such examples, different network operators may determine different types of information (or the same information) to include in the wildcard bits 420, and each operator may indicate to associated or served UEs how to interpret the wildcard bits 420.

For example, a first operator (e.g., operator 1) may use the wildcard bits 420 to classify or identify mobile cells or stationary cells available for the UE 115-b. A second operator (e.g., operator 2) may use the wildcard bits 420 to indicate various ways in which the cell performs network energy savings, or otherwise a network energy saving protocol associated with the cell. A third operator (e.g., operator 3) may use the wildcard bits 420 to indicate that the cell supports RedCap UEs. In some examples, other types of operator-specific information may be included in the wildcard bits 420, or a combination of various different types of operator-specific information.

In some other implementations, the wildcard bits 420 may indicate an information element or a set of information elements (originally included in a SIB1) that are to be conveyed in the MIB 405-b. In such implementations, the network entity 105-b may reduce signaling overhead by utilizing the wildcard bits 420 to convey additional system information, or otherwise combine information that was originally included in separate signaling. In some other implementations, the wildcard bits 420 may indicate whether a separately provided configuration (e.g., a communication configuration such as a semi-persistent scheduling configuration or other scheduling configuration communicated in a separate control message) is currently in effect, or whether the UE 115-b should refrain from applying the configuration.

In some examples, the information included in the wildcard bits 420 may be upgraded to be included as part of the quantity of information elements 410-b (e.g., IE 1, IE 2, IE 3, IE 4, through IE N), which include the specified or set system information, based on an agreement or consensus (e.g., between operators or companies). In some examples, the quantity of reserved bits 415-b may be changed to wildcard bits, so that the MIB design for MIB 405-b includes only wildcard bits and specified information elements. In such examples, a value or a subset of the wildcard bits 420 may be reserved for forward compatibility to indicate the upgrade (e.g., a permanent upgrade) of the subset of the wildcard bits 420 to be included in the quantity of information elements 410-b. While the example of MIB 405-b includes 3 wildcard bits 420, the MIB 405-b may include different quantities of wildcard bits 420 based on different MIB designs.

In some aspects, the network entity 105-b may transmit signaling to the UE 115-b which conveys a meaning of the wildcard bits 420. For example, the signaling may include an indication of how the UE 115-b should interpret the wildcard bits 420, or may indicate whether the wildcard bits 420 should be used in full, in part, or not at all by the UE 115-b. In some examples, the signaling may be included in a value (e.g., a subset) of the wildcard bits 420, such that one or more of the wildcard bits 420 may be used to indicate which wildcard bits 420 are indicated for use by the UE 115-b. For example, different quantities of wildcard bits may be utilized based on different bandwidth capabilities, and may be used to support bandwidth compatibility for different cells that the UE 115-b may connect with. In some other examples (e.g., in cases of non-access stratum signaling of wildcard bit significance, and in the absence of RRC signaling form the network entity 105-b) the UE 115-b may determine whether or not to use the wildcard bits 420 based on prior access to a home public land mobile network (H-PLMN). In some aspects, the signaling of the wildcard bits 420 may be flexibly or dynamically configured (e.g., using RRC signaling or other control signaling) and may be more efficient than using the quantity of reserved bits 415-b for information. For example, each reserved bit may effectively convey ½ bit of information instead of a full bit of information available for a wildcard bit. The use of the wildcard bit may allow for signaling both information to UEs, and information used to identify a type of cell broadcasting information.

The network entity 105-b (or an operator associated with the network entity 105-b) may utilize different configurations or signaling (e.g., one or more control messages) in order to inform the UE 115-b of how to interpret the content of the wildcard bits 420. For example, the network entity 105-a may inform the UE 115-b of the content of the wildcard bits 420 via subscription. In such examples, the content or interpretation of the wildcard bits 420 may be preconfigured at the UE 115-b, or may be dynamically conveyed via signaling by the network entity 105-b. In some examples, the network entity 105-a may inform the UE 115-b of the content of the wildcard bits 420 via a policy. In such examples, the UE 115-b may establish a connection with the network entity 105-b, and may receive a policy after connection which includes an indication of the content or interpretation of the wildcard bits 420. In some examples, the UE 115-b may receive an indication of the content or interpretation of the wildcard bits 420 via a SIB (e.g., a SIB1 of the serving cell, or via different SIBs of other cells), via dedicated signaling, or via one or more assisting UEs. In some examples, the UE 115-b may access data stored in a cloud database, a cloud server, or another server or database, which may include an indication of the content or interpretation of the wildcard bits 420. In such examples, the cloud database or cloud server may gather (e.g., combine, process) information based on updates sent by other UEs and other network entities in addition to information from the network entity 105-b and the UE 115-b, which may include information regarding the content of the wildcard bits.

In some aspects, the interpretation of the wildcard bits 420 may be location specific (e.g., based on a geo-location of the UE 115-b or the network entity 105-b, or both), operator specific, cell specific, or may be based on various other factors associated with the UE 115-b, the network entity 105-b, or both, or any combination thereof. In some implementations, the network entity 105-b may indicate a validity duration for the interpretation of the wildcard bits 420. For example, the network entity 105-b may indicate that an interpretation of the wildcard bits may be valid for a threshold time duration, and that the interpretation may be invalid after the passage of the threshold time duration. In some such examples, the network entity 105-b may include an indication of the time duration in signaling to the UE 115-b (e.g., along with the wildcard bits 420 or in separate signaling). Additionally, or alternatively, the network entity 105-b or the UE 115-b may start a timer that indicates the validity duration. In some implementations, after receiving the wildcard bits 420, the UE 115-b may include an indication of the observed wildcard bits (or associated measurements associated with the wildcard bits 420) in a measurement report that the UE 115-b may send to the network entity 105-b.

In some aspects, the UE 115-b may be a multi-subscriber identity module (SIM) device, and the UE 115-b may receive, at a first SIM, an indication of the content or interpretation of the wildcard bits 420 (or an interpretation of the MIB) associated with a first operator or subscription associated with the first SIM. The first SIM of the UE 115-b may then share the information regarding the interpretation of the wildcard bits 420 with one or more other SIMs of the UE 115-b. In some other aspects, the UE 115-b may be part of a group of UEs (e.g., a cooperative UE group). In some examples, the UE 115-b may receive an indication of the content or interpretation of the wildcard bits 420 (or an interpretation of the MIB), and may share the indication of the content or interpretation of the wildcard bits 420 with other UEs in the group of UEs (e.g., via sidelink signaling or other UE-to-UE information sharing techniques).

The UE 115-b may utilize various techniques (or a combination of the techniques) described herein to interpret the wildcard bits 420 in the MIB 405-b. In some aspects, the UE 115-b may obtain information prior to receiving the MIB 405-b, or after receiving the MIB 405-b. Acquiring knowledge of the wildcard bits 420 in the MIB 405-b may allow for the UE 115-b to perform cell search and connection more efficiently, and may allow the operator to more specifically tailor the connection that the UE 115-b performs with the network entity 105-b.

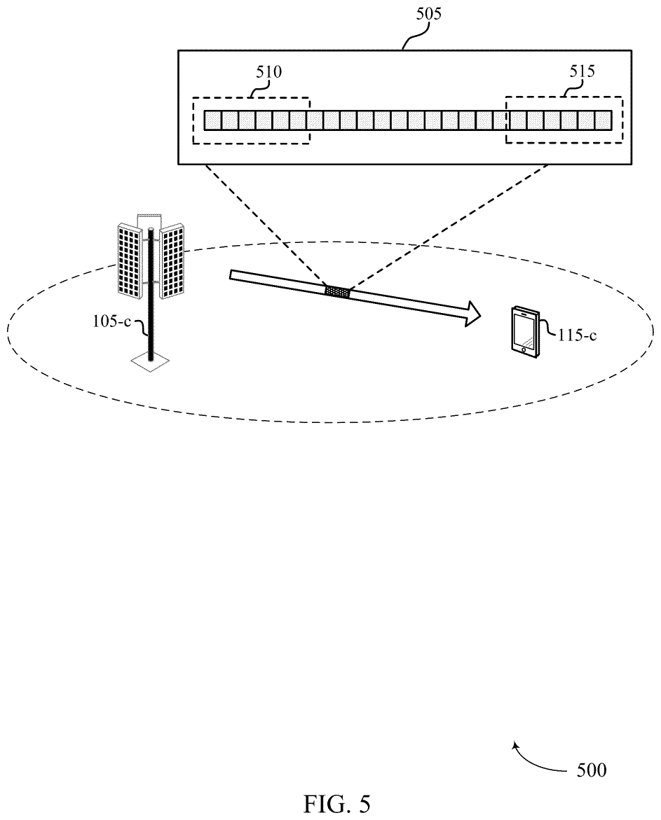

FIG. 5 shows an example of a wireless communications system 500 that supports techniques for efficient MIB and PCI signaling in accordance with one or more aspects of the present disclosure. For example, the wireless communications system 500 illustrates signaling between a UE 115-c and a network entity 105-c, each of which may be an example of corresponding UEs 115 and network entities 105 described herein.

In addition to receiving a MIB, the UE 115-c may receive a PCI 505, which is a multi-bit (e.g., 24-bit) indicator that represents the physical layer identifier of a specific cell served by a network entity 105-c. In some aspects, the UE 115-c may use the PCI for cell synchronization, cell identification, information scrambling (or identifying scrambled information), and reduces the likelihood that the UE 115-c connects to the wrong cell, or that unauthorized users gain access to the cell.

In some implementations, the network entity 105-c may partition the bits of the PCI 505 to include information regarding different functionalities or attributes of serving cells associated with the PCI 505. For example, the network entity 105-c may use a quantity of bits (e.g., x bits) included in the most significant bits 510 or the least significant bits 515 (or other bit strings) of the PCI 505 encoded by a cell SSB to indicate whether a cell supports one or more functionalities, or has one or more specific attributes. For example, the signaling of different functionalities, attributes, or other system information using specified bits in the PCI 505 may allow for efficient partitioning of serving cells based on cell identifiers. For example, using the specified bits in the PCI 505, the UE 115-c may be able to determine which cells include various different functionalities or attributes, and may be able to more efficiently determine which cell to establish a connection with.

In some examples, the location of the bit substring that includes additional system information (and the content of the additional system information) in the PCI 505 may be hard coded. For example, the bit substring which includes the additional system information may have a set location in the PCI 505, and may have set content that is known by the UE 115-c. In some examples, the location of the bit substring and the content of the system information included in the PCI 505 may be operator specific. For example, the UE 115-c may identify (e.g., learn, determine) the structure of the PCI 505 based on one or more prior connections with the network entity 105-c, in which the UE 115-c receives the PCI 505. Additionally, or alternatively, the UE 115-c may identify (e.g., learn, determine) the structure of the PCI 505 based on receiving system information, control signaling, or other signaling that includes information related to the structure of the PCI 505. In some other examples, the UE 115-c may identify the structure of the PCI 505 by observing patterns of different PCIs from system information of multiple other cells (or based on prior connection with multiple other cells and acquisition of other associated PCIs).

In some implementations, the network entity 105-c may inform the UE 115-c of the location of the bit substring and the content of the system information included in the PCI 505 via a subscription or subscription data. In such examples, the content or interpretation of the system information in the bit substring may be preconfigured at the UE 115-c, or may be dynamically conveyed via signaling by the network entity 105-c (e.g., via subscription data). In some examples, the network entity 105-c may inform the UE 115-c of what kinds of system information is encoded in a bit substring of the PCI 505 via a policy. In such examples, the UE 115-c may establish a connection with the network entity 105-c, and may receive a policy after connection which includes an indication of the content or interpretation of the system information included in the bit substring of the PCI 505. In some examples, the UE 115-c may receive an indication of which system information is encoded in which bit substring of the PCI 505 via a SIB (e.g., a SIB1 of the serving cell, or via different SIBs of other cells), via dedicated signaling, or via one or more assisting UEs. In some examples, the UE 115-c may access data stored in a cloud database, a cloud server, or another server or database, which may include an indication of which system information is included in which bit substring of the PCI 505. In such examples, the cloud database or cloud server may gather (e.g., combine, process) information based on updates sent by other UEs and other network entities in addition to information from the network entity 105-c and the UE 115-c, which may include information regarding the content of the bit substring including the system information.

In some aspects, the UE 115-c may be a multi-SIM device, and the UE 115-c may receive, at a first SIM, an indication of the content or interpretation of the bits included in the PCI 505 (e.g., a location of system information in a bit substring of the PCI) associated with a first operator or subscription associated with the first SIM. The first SIM of the UE 115-c may then share the information regarding the interpretation of the PCI 505 with one or more other SIMs of the UE 115-c. In some other aspects, the UE 115-c may be part of a group of UEs (e.g., a cooperative UE group). In some examples, the UE 115-b may receive an in indication of the content or interpretation of the bits included in the PCI 505, and may share the indication of the content or interpretation of the PCI 505 with other UEs in the group of UEs (e.g., via sidelink signaling or other UE-to-UE information sharing techniques).

In some implementations, the network entity 105-c may use the PCI 505 in combination with the PBCH (e.g., including MIB bits and scrambling identities included in the PBCH), DMRS, or both, to encode system information. For example, the MIB, the PCI, or both, may be used to indicate system information the UE 115-c may use to perform initial access with the cell. In such examples, the UE 115-c may use the additional system information included in the MIB, the PCI, or both, to determine whether the cell is suitable for connection with the UE 115-c (e.g., whether or not the cell provides reliable service based on service quality, among other factors). In some aspects, the UE 115-c may determine, based on the additional system information, that the cell is suitable for access, and may connect with the cell. In some other aspects, if the UE 115-c determines that the cell is not suitable for access, then the UE 115-c may refrain from performing initial access, which may save the UE 115-c time and power.

The UE 115-c may utilize various techniques (or a combination of the techniques) described herein to interpret the bits included in the PCI 505, including which bit substring of the PCI 505 includes different system information. In some aspects, the UE 115-c may obtain information prior to receiving a MIB or the PCI 505, or after receiving the MIB the PCI 505. Acquiring knowledge of the structure of the PCI 505 may allow for the UE 115-c to perform cell search and connection more efficiently, and may allow the operator to more specifically tailor the connection that the UE 115-c performs with the network entity 105-c.

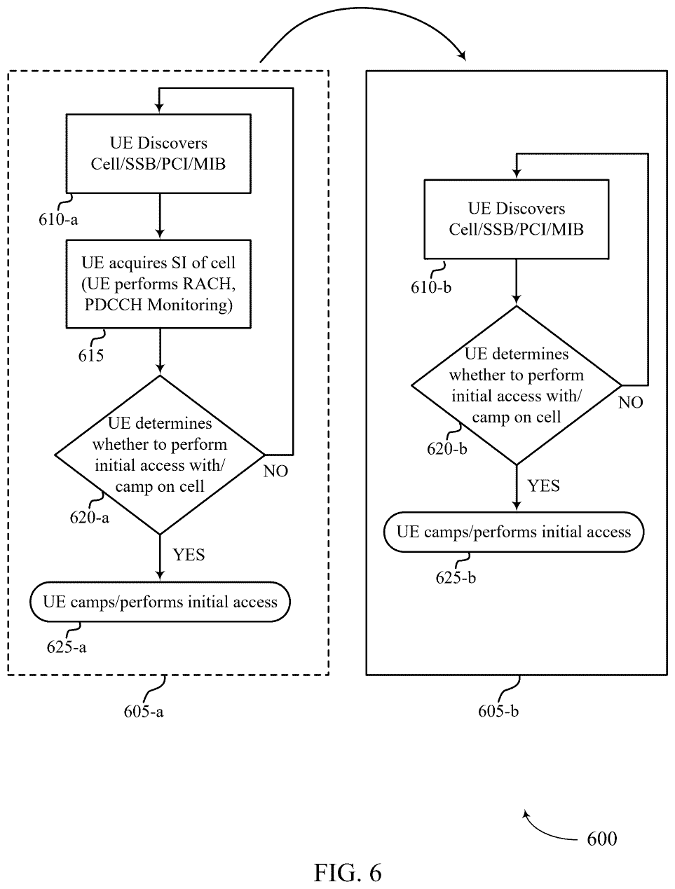

FIG. 6 shows example cell search procedures 600 that supports techniques for efficient MIB and PCI signaling in accordance with one or more aspects of the present disclosure. For example, the cell search procedures 600 may illustrate possible initial access processes performed between a UE and a network entity, which may be examples of UEs 115 and network entities 105 described herein.

For a first example cell search procedure 605-a, the UE at 610-a may discover a cell, SSB, PCI, MIB, or any combination thereof, as a candidate for initial access. At 615, the UE may acquire system information of the cell, which may include performing a random access channel (RACH) procedure, monitoring for PDCCH (which may include latency for receiving system information and SIB1). At step 620-a, the UE may determine whether the cell is adequate to camp on, or to perform initial access with. If the UE determines that the cell is inadequate, the UE may return to step 610-a and may repeat the cell search procedure. If the UE determines that the cell is adequate, then the UE may camp on the cell or perform initial access at step 625-a.

In some cases, however, the process of separately acquiring system information of the cell at step 615 may introduce additional latency and signaling overhead. The second cell search procedure 605-b may allow for additional system information to be included in the PCI or MIB, so that the UE may efficiently determine (upon receiving the PCI or MIB), whether the cell is adequate for initial access or camping, effectively bypassing step 615. For example, at 610-b, the UE may discover a cell, SSB, PCI, MIB, or any combination thereof, which may include additional system information of the cell. At step 620-b, the UE may determine whether the cell is adequate to camp on, or to perform initial access with based on the additional system information included in the MIB or PCI. If the UE determines that the cell is inadequate, the UE may return to step 610-b and may repeat the cell search procedure. If the UE determines that the cell is adequate, then the UE may camp on the cell or perform initial access at step 625-b.

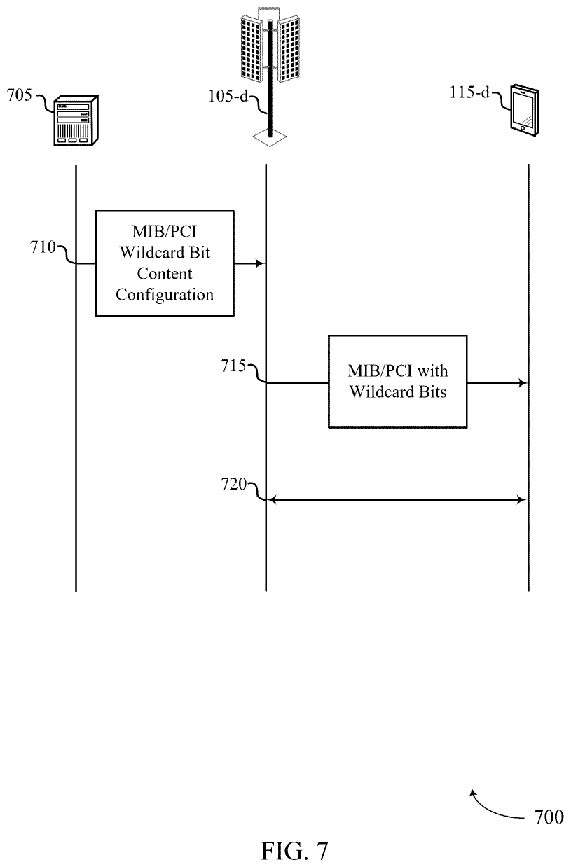

FIG. 7 shows an example of a process flow 700 that supports techniques for efficient MIB and PCI signaling in accordance with one or more aspects of the present disclosure. For example, the process flow 700 illustrates communications between a UE 115-d (which may be an example a UE 115 described herein), a network entity 105-d (which may be an example of a network entity 105 described herein), and a network device 705, which may be an example of network devices or network entities described herein.

Alternative examples of the following may be implemented. Some steps are performed in a different order than described or are not performed at all. In some implementations, steps may include additional features not mentioned below, or additional steps may be added. Further, although the UE 115-d, the network entity 105-d, and the network device 705 are shown performing the operations of the process flow 700, some aspects of some operations may also be performed by one or more other wireless communication devices.

At 710, the network entity 105-d may obtain (e.g., from the network device 705, from a higher layer) a control message that indicates a content configuration for a MIB message, a PCI, or both. In some examples, the content configuration may include an indication of a type of information to be specified by one or more wildcard bits of the MIB message, the PCI, or both. In some examples, the type of information may be indicated at least partially by the MIB message, the PCI, the PBCH, the DMRS, or any combination thereof. For example, the type of information specified by the one or more wildcard bits of the MIB message, the PCI, or both, may be based on an operator associated with the network entity 105-d, a geo-location of the network entity 105-d, a cell of the network entity 105-d, or any combination thereof. In some examples, the control message may indicate a location reserved for the one or more wildcard bits in the MIB message, the PCI, or both. In some examples, the control message may include an indication of a validity duration for the type of information specified by the one or more wildcard bits of the MIB message (e.g., a duration in which an interpretation of the MIB bits is valid).

In some examples, the control message may include an indication of a location of the one or more wildcard bits within a bitstring of the PCI, where the one or more wildcard bits indicate system information. In some examples, the location of the one or more wildcard bits within the bitstring of the PCI may include (or may at least partially overlap with) one or more most significant bits or one or more least significant bits of the PCI. In some aspects, the system information in the PCI may be indicative of a functionality or characteristic of a cell associated with the network entity 105-d.

At 715, the network entity 105-d may output the MIB message, the PCI, or both, including the one or more wildcard bits indicating the type of information. In some aspects, at least one wildcard bit of the one or more wildcard bits is indicative of a mobile cell associated with the network entity 105-d, a stationary cell associated with the network entity 105-d, one or more network energy saving configurations associated with the network entity 105-d, a capability to support reduced capability UEs, one or more information elements of a system information block, or any combination thereof.

In some examples, the network entity 105-d may output, to the UE 115-d, an indication of an interpretation of the type of information of the one or more wildcard bits, where the control message comprises a dynamically signaled message, an RRC message, a policy message, a SIB message, dedicated signaling, an information message that indicate the type of information stored in a cloud environment, or any combination thereof. For example, the type of information may include operator specific information, information regarding initial cell access, or both.

In some implementations, the network entity 105-d may output an indication of a communication configuration associated with the UE 115-d, where an application of the communication configuration is based at least in part on an application indication included in the one or more wildcard bits of the MIB message. In some implementations, the network entity 105-d may output an indication that a quantity of the one or more wildcard bits are fixed bits included in the MIB message, and that the fixed bits are indicative of whether the one or more wildcard bits are activated or deactivated.

In some implementations, the UE 115-d may determine a structure of the PCI including the location of the one or more wildcard bits within the bitstring of the PCI based on the structure of the PCI received during a previous connection with the network entity 105-d, based at least in part on the structure of other physical cell identities received during communication with one or more other network entities, or both. In some other implementations, the UE 115-d may determine a structure of the PCI including the location of the one or more wildcard bits within the bitstring of the PCI based on hard coded information at the UE 115-d.

At 720, the network entity 105-d may communicate (e.g., one or more messages) with the UE 115-d in accordance with the type of information indicated by the one or more wildcard bits of the MIB message, the PCI, or both. In some examples, the UE 115-d may transmit a measurement report that includes one or more measurements associated with contents of the MIB (including the wildcard bit content), an interpretation of the wildcard bits of the MIB message, or both.

In some examples, the network entity 105-d may obtain (e.g., from the network device 705, or from a higher layer) an indication that at least a subset of wildcard bits of the one or more wildcard bits are changed from wildcard bits to one or more standardized information elements of the MIB message. In some examples, the network entity 105-d may transmit, to the UE 115-d, an indication of the one or more wildcard bits changing to one or more standardized information elements of the MIB message.

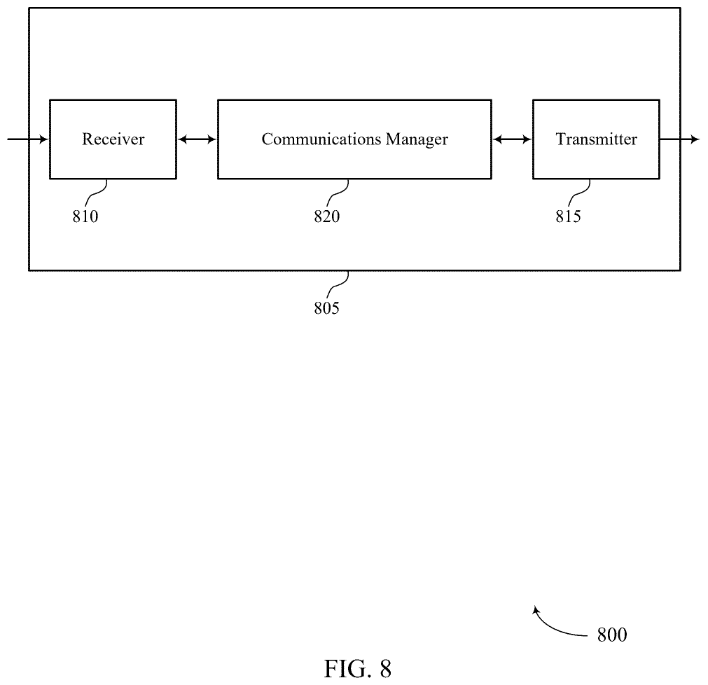

FIG. 8 shows a block diagram 800 of a device 805 that supports techniques for efficient MIB and PCI signaling in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of techniques for efficient MIB and PCI signaling as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for obtaining a control message indicative of a content configuration for a MIB message, a PCI, or both, where the content configuration includes an indication of a type of information to be specified by one or more wildcard bits of the MIB message, the PCI, or both. The communications manager 820 is capable of, configured to, or operable to support a means for outputting the MIB message, the PCI, or both, including the one or more wildcard bits indicating the type of information. The communications manager 820 is capable of, configured to, or operable to support a means for communicating with a UE in accordance with the type of information indicated by the one or more wildcard bits of the MIB message, the PCI, or both.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, more efficient utilization of communication resources, more efficient usage of MIB and PCI bits, enhanced cell search and initial access processes, and improved system information and operator specific information signaling.

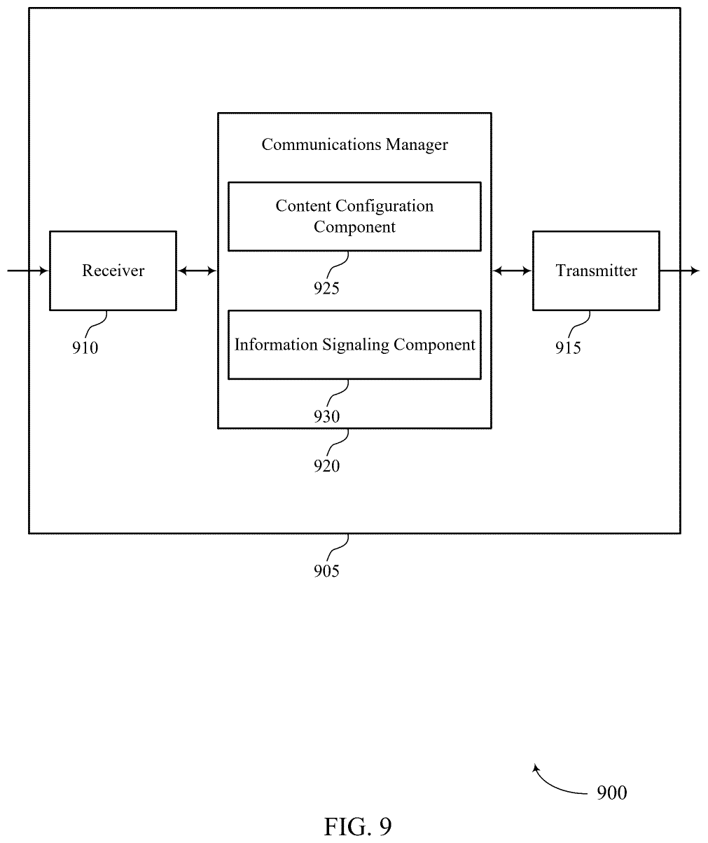

FIG. 9 shows a block diagram 900 of a device 905 that supports techniques for efficient MIB and PCI signaling in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for efficient MIB and PCI signaling as described herein. For example, the communications manager 920 may include a content configuration component 925 an information signaling component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The content configuration component 925 is capable of, configured to, or operable to support a means for obtaining a control message indicative of a content configuration for a MIB message, a PCI, or both, where the content configuration includes an indication of a type of information to be specified by one or more wildcard bits of the MIB message, the PCI, or both. The information signaling component 930 is capable of, configured to, or operable to support a means for outputting the MIB message, the PCI, or both, including the one or more wildcard bits indicating the type of information. The information signaling component 930 is capable of, configured to, or operable to support a means for communicating with a UE in accordance with the type of information indicated by the one or more wildcard bits of the MIB message, the PCI, or both.

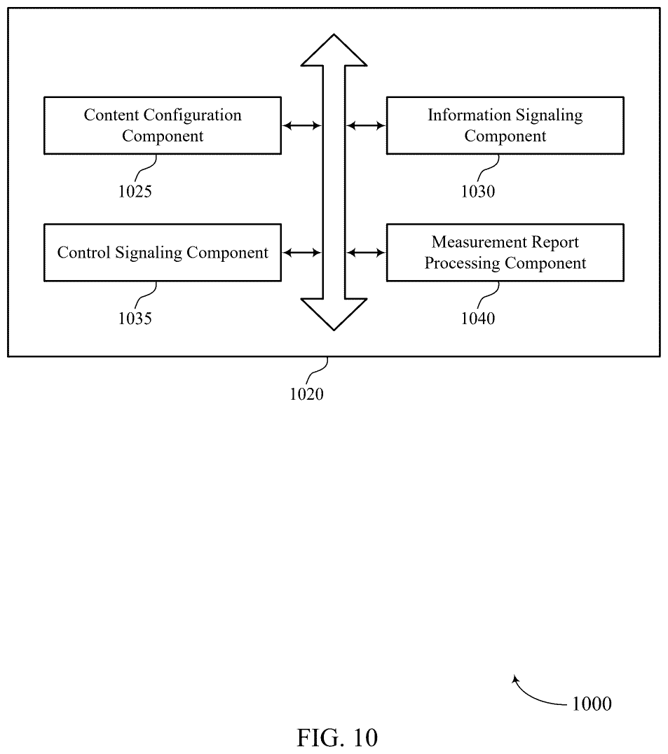

FIG. 10 shows a block diagram 1000 of a communications manager 1020 that supports techniques for efficient MIB and PCI signaling in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for efficient MIB and PCI signaling as described herein. For example, the communications manager 1020 may include a content configuration component 1025, an information signaling component 1030, a control signaling component 1035, a measurement report processing component 1040, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The content configuration component 1025 is capable of, configured to, or operable to support a means for obtaining a control message indicative of a content configuration for a MIB message, a PCI, or both, where the content configuration includes an indication of a type of information to be specified by one or more wildcard bits of the MIB message, the PCI, or both. The information signaling component 1030 is capable of, configured to, or operable to support a means for outputting the MIB message, the PCI, or both, including the one or more wildcard bits indicating the type of information. In some examples, the information signaling component 1030 is capable of, configured to, or operable to support a means for communicating with a UE in accordance with the type of information indicated by the one or more wildcard bits of the MIB message, the PCI, or both.

In some examples, the type of information specified by the one or more wildcard bits of the MIB message, the PCI, or both, is based on an operator associated with the network entity, a geo-location of the network entity, a cell of the network entity, or any combination thereof.

In some examples, to support obtaining the control message indicative of the content configuration for the MIB message, the PCI, or both, the content configuration component 1025 is capable of, configured to, or operable to support a means for obtaining an indication of a location reserved for the one or more wildcard bits in the MIB message, the PCI, or both.

In some examples, to support outputting the MIB message, the PCI, or both, the information signaling component 1030 is capable of, configured to, or operable to support a means for outputting the MIB message, the PCI, or both, where at least one wildcard bit of the one or more wildcard bits is indicative of a mobile cell associated with the network entity, a stationary cell associated with the network entity, one or more network energy saving configurations associated with the network entity, a capability to support reduced capability UEs, one or more information elements of a system information block, or any combination thereof.

In some examples, the information signaling component 1030 is capable of, configured to, or operable to support a means for outputting an indication of a communication configuration associated with the UE, where an application of the communication configuration is based on an application indication included in the one or more wildcard bits.

In some examples, to support outputting the MIB message, the PCI, or both, the information signaling component 1030 is capable of, configured to, or operable to support a means for outputting an indication that a quantity of the one or more wildcard bits include fixed bits indicative of whether the one or more wildcard bits are activated or deactivated.

In some examples, to support obtaining the control message indicative of the content configuration for the MIB message, the content configuration component 1025 is capable of, configured to, or operable to support a means for obtaining an indication that at least a subset of wildcard bits of the one or more wildcard bits are changed from wildcard bits to one or more standardized information elements of the MIB message.

In some examples, the control signaling component 1035 is capable of, configured to, or operable to support a means for outputting, to the UE, an indication of an interpretation of the type of information of the one or more wildcard bits, where the control message includes a dynamically signaled message, a radio resource control message, a policy message, a system information block message, dedicated signaling, an information message that indicate the type of information stored in a cloud environment, or any combination thereof.

In some examples, the control message indicative of the content configuration for the MIB message, the PCI, or both, includes an indication of a validity duration for the type of information specified by the one or more wildcard bits.

In some examples, the measurement report processing component 1040 is capable of, configured to, or operable to support a means for receiving, from the UE, a measurement report indicative of an interpretation of the one or more wildcard bits by the UE.

In some examples, the one or more wildcard bits included in the PCI include one or more most significant bits or one or more least significant bits, and are indicative of a functionality or a characteristic of a cell associated with the network entity.

In some examples, to support obtaining the control message indicative of the content configuration for the PCI, the content configuration component 1025 is capable of, configured to, or operable to support a means for obtaining the control message including an indication of a location of the one or more wildcard bits within a bitstring of the PCI, where the one or more wildcard bits indicate system information. In some examples, the content configuration component 1025 is capable of, configured to, or operable to support a means for obtaining the control message via signaling between one or more network interfaces associated with the network entity, the one or more network interfaces comprising a centralized unit to distributed unit F1 interface, a centralized unit to centralized unit Xn interface, a core network interface, or any combination thereof.

In some examples, the type of information includes system information that is indicated at least in part by the PCI, a physical broadcast channel, the MIB message, one or more demodulation reference signals, or any combination thereof.

In some examples, to support outputting the MIB message, the PCI, or both, the information signaling component 1030 is capable of, configured to, or operable to support a means for outputting the MIB message, the PCI, or both, including an indication of system information for initial access to a cell associated with the network entity.

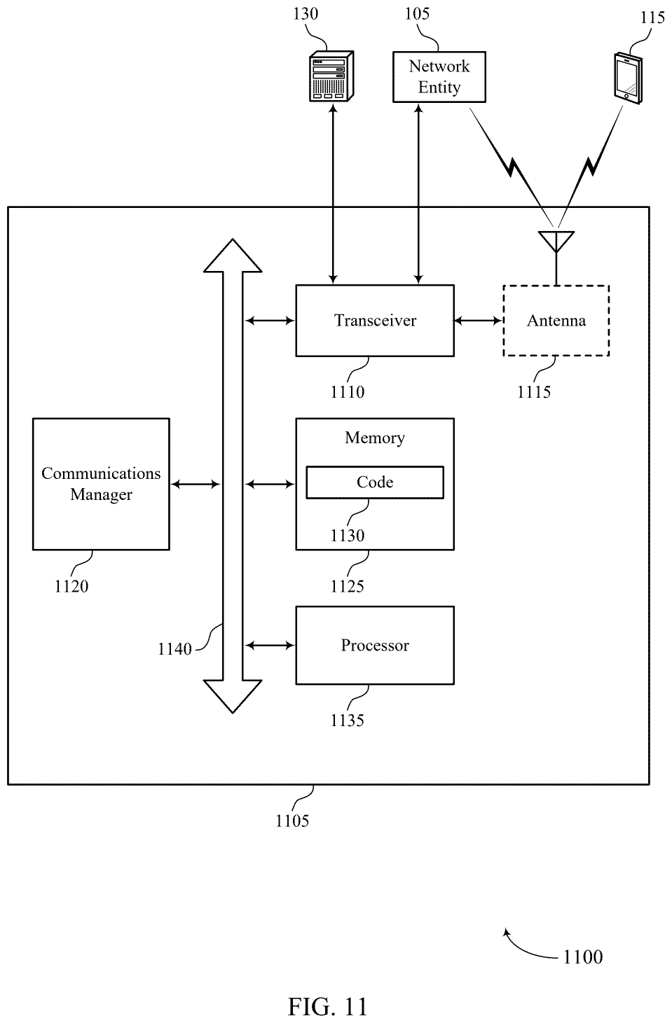

FIG. 11 shows a diagram of a system 1100 including a device 1105 that supports techniques for efficient MIB and PCI signaling in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for efficient MIB and PCI signaling). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for obtaining a control message indicative of a content configuration for a MIB message, a PCI, or both, where the content configuration includes an indication of a type of information to be specified by one or more wildcard bits of the MIB message, the PCI, or both. The communications manager 1120 is capable of, configured to, or operable to support a means for outputting the MIB message, the PCI, or both, including the one or more wildcard bits indicating the type of information. The communications manager 1120 is capable of, configured to, or operable to support a means for communicating with a UE in accordance with the type of information indicated by the one or more wildcard bits of the MIB message, the PCI, or both.

By including or configuring the communications manager 1120 in accordance with examples as described herein, the device 1105 may support techniques for improved communication reliability, reduced latency related to obtaining system information, improved user experience related to reduced processing, reduced power consumption, more efficient utilization of communication resources, improved coordination between devices, longer battery life, improved utilization of processing capability, improved cell search and initial access procedures, improved cell selection accuracy and efficiency, and reduced signaling overhead.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for efficient MIB and PCI signaling as described herein, or the at least one processor 1135 and the at least one memory 1125 may be otherwise configured to, individually or collectively, perform or support such operations.

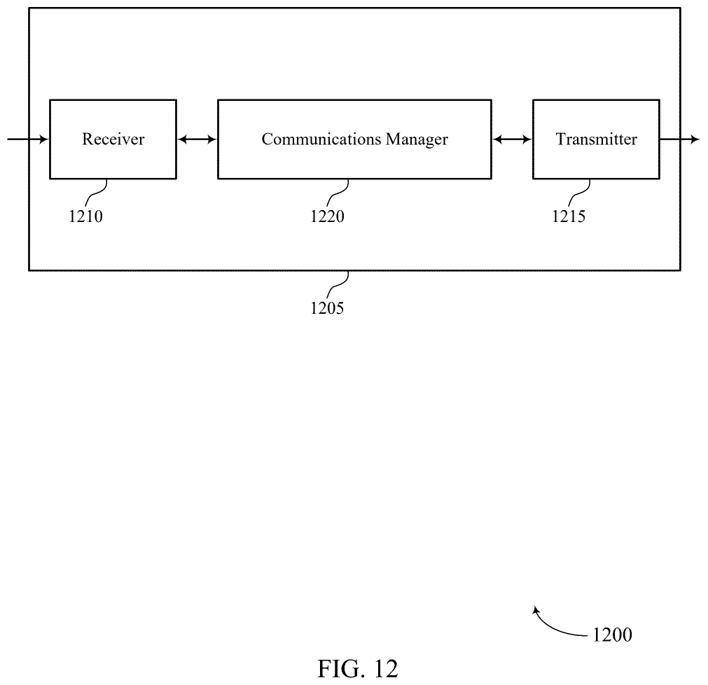

FIG. 12 shows a block diagram 1200 of a device 1205 that supports techniques for efficient MIB and PCI signaling in accordance with one or more aspects of the present disclosure. The device 1205 may be an example of aspects of a UE 115 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to techniques for efficient MIB and PCI signaling). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to techniques for efficient MIB and PCI signaling). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations or components thereof may be examples of means for performing various aspects of techniques for efficient MIB and PCI signaling as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for receiving a control message indicative of a content configuration for a MIB message, a PCI, or both, where the content configuration includes an indication of a type of information specified by one or more wildcard bits of the MIB message, the PCI, or both. The communications manager 1220 is capable of, configured to, or operable to support a means for receiving the MIB message, the PCI, or both, including one or more wildcard bits. The communications manager 1220 is capable of, configured to, or operable to support a means for communicating with a network entity in accordance with the type of information indicated by the one or more wildcard bits of the MIB message, the PCI, or both.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced processing, reduced power consumption, more efficient utilization of communication resources, more efficient usage of MIB and PCI bits, enhanced cell search and initial access processes, and improved system information and operator specific information signaling.

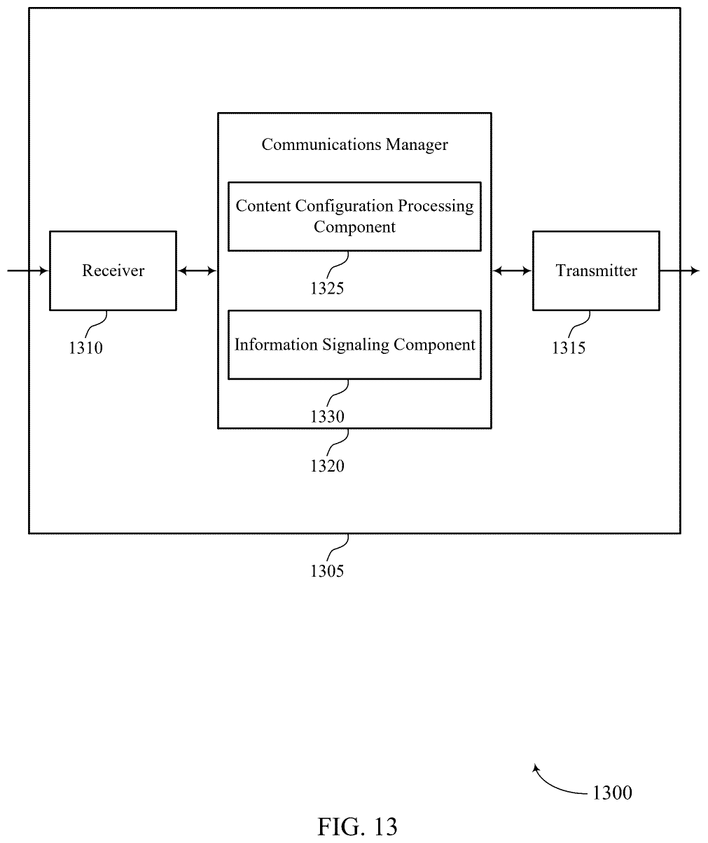

FIG. 13 shows a block diagram 1300 of a device 1305 that supports techniques for efficient MIB and PCI signaling in accordance with one or more aspects of the present disclosure. The device 1305 may be an example of aspects of a device 1205 or a UE 115 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for receiving information such as packets, user data, control information, or any combination thereof associated with various information channels (e.g., control channels, data channels, information channels related to techniques for efficient MIB and PCI signaling). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to techniques for efficient MIB and PCI signaling). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of techniques for efficient MIB and PCI signaling as described herein. For example, the communications manager 1320 may include a content configuration processing component 1325 an information signaling component 1330, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The content configuration processing component 1325 is capable of, configured to, or operable to support a means for receiving a control message indicative of a content configuration for a MIB message, a PCI, or both, where the content configuration includes an indication of a type of information specified by one or more wildcard bits of the MIB message, the PCI, or both. The information signaling component 1330 is capable of, configured to, or operable to support a means for receiving the MIB message, the PCI, or both, including one or more wildcard bits. The information signaling component 1330 is capable of, configured to, or operable to support a means for communicating with a network entity in accordance with the type of information indicated by the one or more wildcard bits of the MIB message, the PCI, or both.

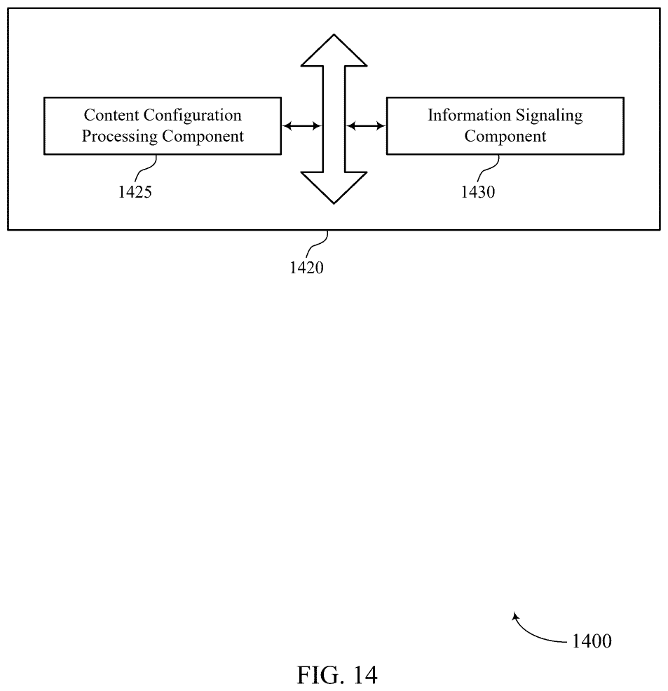

FIG. 14 shows a block diagram 1400 of a communications manager 1420 that supports techniques for efficient MIB and PCI signaling in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of techniques for efficient MIB and PCI signaling as described herein. For example, the communications manager 1420 may include a content configuration processing component 1425 an information signaling component 1430, or any combination thereof. Each of these components, or components or subcomponents thereof (e.g., one or more processors, one or more memories), may communicate, directly or indirectly, with one another (e.g., via one or more buses).

The communications manager 1420 may support wireless communications in accordance with examples as disclosed herein. The content configuration processing component 1425 is capable of, configured to, or operable to support a means for receiving a control message indicative of a content configuration for a MIB message, a PCI, or both, where the content configuration includes an indication of a type of information specified by one or more wildcard bits of the MIB message, the PCI, or both. The information signaling component 1430 is capable of, configured to, or operable to support a means for receiving the MIB message, the PCI, or both, including one or more wildcard bits. In some examples, the information signaling component 1430 is capable of, configured to, or operable to support a means for communicating with a network entity in accordance with the type of information indicated by the one or more wildcard bits of the MIB message, the PCI, or both.

In some examples, to support receiving the control message indicative of the content configuration for the MIB message, the PCI, or both, the content configuration processing component 1425 is capable of, configured to, or operable to support a means for receiving an indication of a location reserved for the one or more wildcard bits in the MIB message, the PCI, or both.

In some examples, to support receiving the MIB message, the PCI, or both, the information signaling component 1430 is capable of, configured to, or operable to support a means for receiving the MIB message, the PCI, or both, where at least one wildcard bit of the one or more wildcard bits is indicative of a mobile cell associated with the network entity, a stationary cell associated with the network entity, one or more network energy saving configurations associated with the network entity, a capability to support reduced capability UEs, one or more information elements of a system information block, or any combination thereof.

In some examples, the content configuration processing component 1425 is capable of, configured to, or operable to support a means for receiving an indication of a communication configuration associated with the UE, where an application of the communication configuration is based on an application indication included in the one or more wildcard bits. In some examples, to support receiving the MIB message, the PCI, or both, the content configuration processing component 1425 is capable of, configured to, or operable to support a means for receiving an indication that a quantity of the one or more wildcard bits include fixed bits indicative of whether the one or more wildcard bits are activated or deactivated.

In some examples, the content configuration processing component 1425 is capable of, configured to, or operable to support a means for receiving an indication of an interpretation of the type of information of the one or more wildcard bits, where the control message includes a dynamically signaled message, a radio resource control message, a policy message, a system information block message, dedicated signaling, an information message that indicate the type of information stored in a cloud environment, or any combination thereof. In some examples, the control message indicative of the content configuration for the MIB message, the PCI, or both, includes an indication of a validity duration for the type of information specified by the one or more wildcard bits.

In some examples, the information signaling component 1430 is capable of, configured to, or operable to support a means for transmitting a measurement report indicative of an interpretation of the one or more wildcard bits by the UE. In some examples, the one or more wildcard bits included in the PCI include one or more most significant bits or one or more least significant bits, and are indicative of a functionality or a characteristic of a cell associated with the network entity.

In some examples, to support receiving the control message indicative of the content configuration for the PCI, the content configuration processing component 1425 is capable of, configured to, or operable to support a means for receiving the control message including an indication of a location of the one or more wildcard bits within a bitstring of the PCI, where the one or more wildcard bits indicate system information.

In some examples, the content configuration processing component 1425 is capable of, configured to, or operable to support a means for determining a structure of the PCI including the location of the one or more wildcard bits within the bitstring of the PCI based on the structure of the PCI received during a previous connection with the network entity, based on the structure of other physical cell identities received during communication with one or more other network entities, or both.

In some examples, the content configuration processing component 1425 is capable of, configured to, or operable to support a means for determining a structure of the PCI including the location of the one or more wildcard bits within the bitstring of the PCI based on hard coded information at the UE. In some examples, the type of information includes system information that is indicated at least in part by the PCI, a physical broadcast channel, the MIB message, one or more demodulation reference signals, or any combination thereof.

In some examples, to support receiving the MIB message, the PCI, or both, the information signaling component 1430 is capable of, configured to, or operable to support a means for receiving the MIB message, the PCI, or both, including an indication of system information for initial access to a cell associated with the network entity. In some examples, to support receiving the MIB message, the PCI, or both, the information signaling component 1430 is capable of, configured to, or operable to support a means for performing an initial access procedure based on the indication of system information.

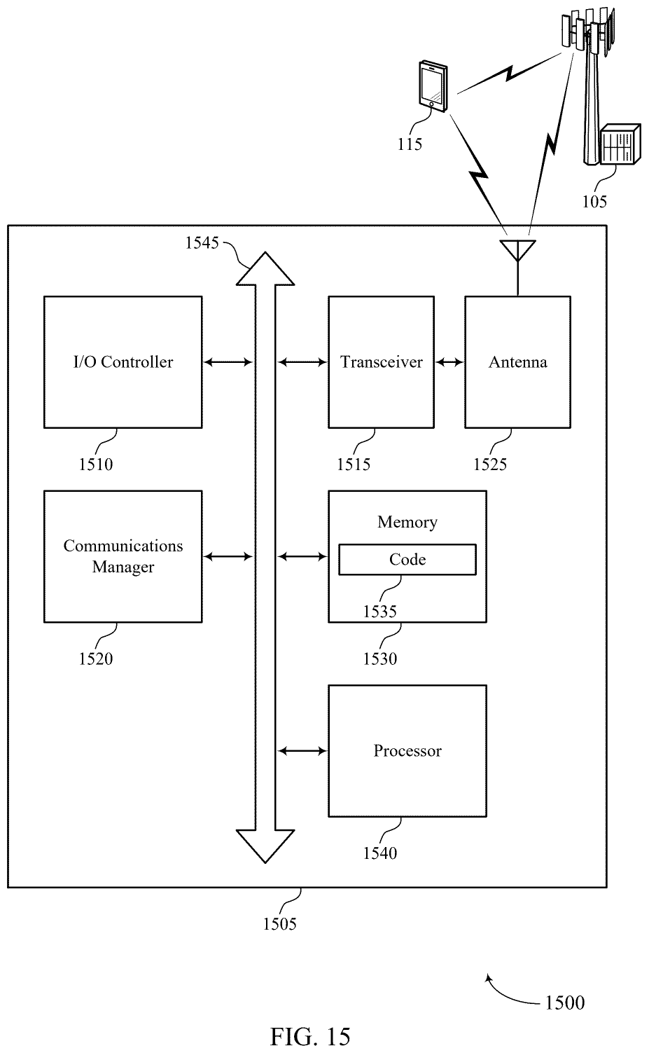

FIG. 15 shows a diagram of a system 1500 including a device 1505 that supports techniques for efficient MIB and PCI signaling in accordance with one or more aspects of the present disclosure. The device 1505 may be an example of or include components of a device 1205, a device 1305, or a UE 115 as described herein. The device 1505 may communicate (e.g., wirelessly) with one or more other devices (e.g., network entities 105, UEs 115, or a combination thereof). The device 1505 may include components for bi-directional voice and data communications including components for transmitting and receiving communications, such as a communications manager 1520, an input/output (I/O) controller, such as an I/O controller 1510, a transceiver 1515, one or more antennas 1525, at least one memory 1530, code 1535, and at least one processor 1540. These components may be in electronic communication or otherwise coupled (e.g., operatively, communicatively, functionally, electronically, electrically) via one or more buses (e.g., a bus 1545).

The I/O controller 1510 may manage input and output signals for the device 1505. The I/O controller 1510 may also manage peripherals not integrated into the device 1505. In some cases, the I/O controller 1510 may represent a physical connection or port to an external peripheral. In some cases, the I/O controller 1510 may utilize an operating system such as iOS®, ANDROID®, MS-DOS®, MS-WINDOWS®, OS/2®, UNIX®, LINUX®, or another known operating system. Additionally, or alternatively, the I/O controller 1510 may represent or interact with a modem, a keyboard, a mouse, a touchscreen, or a similar device. In some cases, the I/O controller 1510 may be implemented as part of one or more processors, such as the at least one processor 1540. In some cases, a user may interact with the device 1505 via the I/O controller 1510 or via hardware components controlled by the I/O controller 1510.

In some cases, the device 1505 may include a single antenna. However, in some other cases, the device 1505 may have more than one antenna, which may be capable of concurrently transmitting or receiving multiple wireless transmissions. The transceiver 1515 may communicate bi-directionally via the one or more antennas 1525 using wired or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The at least one memory 1530 may include random access memory (RAM) and read-only memory (ROM). The at least one memory 1530 may store computer-readable, computer-executable, or processor-executable code, such as the code 1535. The code 1535 may include instructions that, when executed by the at least one processor 1540, cause the device 1505 to perform various functions described herein. The code 1535 may be stored in a non-transitory computer-readable medium such as system memory or another type of memory. In some cases, the code 1535 may not be directly executable by the at least one processor 1540 but may cause a computer (e.g., when compiled and executed) to perform functions described herein. In some cases, the at least one memory 1530 may include, among other things, a basic I/O system (BIOS) which may control basic hardware or software operation such as the interaction with peripheral components or devices.

The at least one processor 1540 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1540 may be configured to operate a memory array using a memory controller. In some other cases, a memory controller may be integrated into the at least one processor 1540. The at least one processor 1540 may be configured to execute computer-readable instructions stored in a memory (e.g., the at least one memory 1530) to cause the device 1505 to perform various functions (e.g., functions or tasks supporting techniques for efficient MIB and PCI signaling). For example, the device 1505 or a component of the device 1505 may include at least one processor 1540 and at least one memory 1530 coupled with or to the at least one processor 1540, the at least one processor 1540 and the at least one memory 1530 configured to perform various functions described herein.

In some examples, the at least one processor 1540 may include multiple processors and the at least one memory 1530 may include multiple memories. One or more of the multiple processors may be coupled with one or more of the multiple memories, which may, individually or collectively, be configured to perform various functions described herein. In some examples, the at least one processor 1540 may be a component of a processing system, which may refer to a system (such as a series) of machines, circuitry (including, for example, one or both of processor circuitry (which may include the at least one processor 1540) and memory circuitry (which may include the at least one memory 1530)), or components, that receives or obtains inputs and processes the inputs to produce, generate, or obtain a set of outputs. The processing system may be configured to perform one or more of the functions described herein. For example, the at least one processor 1540 or a processing system including the at least one processor 1540 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code 1535 (e.g., processor-executable code) stored in the at least one memory 1530 or otherwise, to perform one or more of the functions described herein.

The communications manager 1520 may support wireless communications in accordance with examples as disclosed herein. For example, the communications manager 1520 is capable of, configured to, or operable to support a means for receiving a control message indicative of a content configuration for a MIB message, a PCI, or both, where the content configuration includes an indication of a type of information specified by one or more wildcard bits of the MIB message, the PCI, or both. The communications manager 1520 is capable of, configured to, or operable to support a means for receiving the MIB message, the PCI, or both, including one or more wildcard bits. The communications manager 1520 is capable of, configured to, or operable to support a means for communicating with a network entity in accordance with the type of information indicated by the one or more wildcard bits of the MIB message, the PCI, or both.

By including or configuring the communications manager 1520 in accordance with examples as described herein, the device 1505 may support techniques for improved communication reliability, reduced latency related to obtaining system information, improved user experience related to reduced processing, reduced power consumption, more efficient utilization of communication resources, improved coordination between devices, longer battery life, improved utilization of processing capability, improved cell search and initial access procedures, improved cell selection accuracy and efficiency, and reduced signaling overhead.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the at least one processor 1540, the at least one memory 1530, the code 1535, or any combination thereof. For example, the code 1535 may include instructions executable by the at least one processor 1540 to cause the device 1505 to perform various aspects of techniques for efficient MIB and PCI signaling as described herein, or the at least one processor 1540 and the at least one memory 1530 may be otherwise configured to, individually or collectively, perform or support such operations.

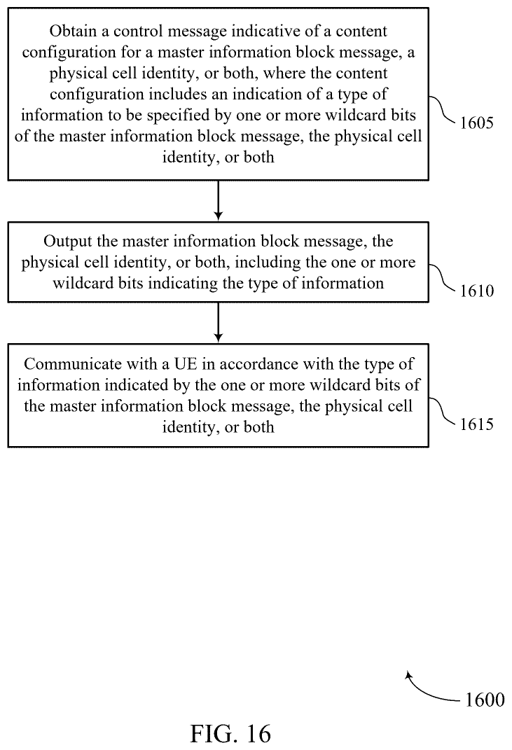

FIG. 16 shows a flowchart illustrating a method 1600 that supports techniques for efficient MIB and PCI signaling in accordance with one or more aspects of the present disclosure. The operations of the method 1600 may be implemented by a network entity or its components as described herein. For example, the operations of the method 1600 may be performed by a network entity as described with reference to FIGS. 1 through 11. In some examples, a network entity may execute a set of instructions to control the functional elements of the network entity to perform the described functions. Additionally, or alternatively, the network entity may perform aspects of the described functions using special-purpose hardware.

At 1605, the method may include obtaining a control message indicative of a content configuration for a MIB message, a PCI, or both, where the content configuration includes an indication of a type of information to be specified by one or more wildcard bits of the MIB message, the PCI, or both. The operations of 1605 may be performed in accordance with examples as disclosed herein. In some examples, aspects of the operations of 1605 may be performed by a content configuration component 1025 as described with reference to FIG. 10.

At 1610, the method may include outputting the MIB message, the PCI, or both, including the one or more wildcard bits indicating the type of information. The operations of 1610 may be performed in accordance with examples as disclosed herein. In some examples, aspects of the operations of 1610 may be performed by an information signaling component 1030 as described with reference to FIG. 10.

At 1615, the method may include communicating with a UE in accordance with the type of information indicated by the one or more wildcard bits of the MIB message, the PCI, or both. The operations of 1615 may be performed in accordance with examples as disclosed herein. In some examples, aspects of the operations of 1615 may be performed by an information signaling component 1030 as described with reference to FIG. 10.

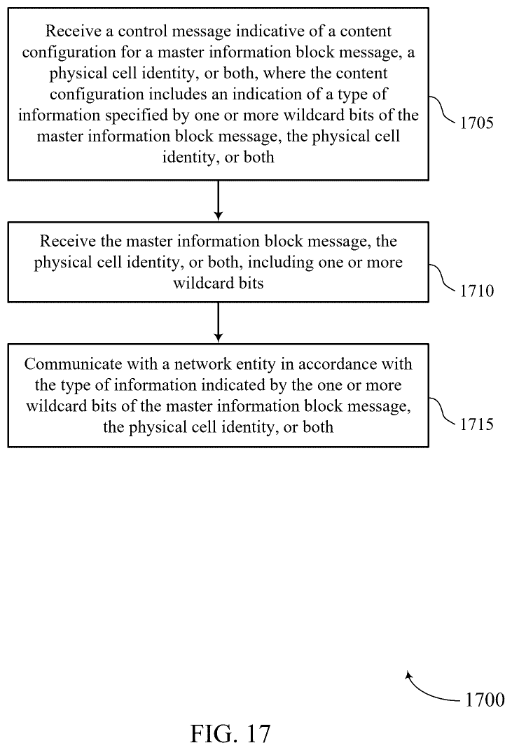

FIG. 17 shows a flowchart illustrating a method 1700 that supports techniques for efficient MIB and PCI signaling in accordance with one or more aspects of the present disclosure. The operations of the method 1700 may be implemented by a UE or its components as described herein. For example, the operations of the method 1700 may be performed by a UE 115 as described with reference to FIGS. 1 through 7 and 12 through 15. In some examples, a UE may execute a set of instructions to control the functional elements of the UE to perform the described functions. Additionally, or alternatively, the UE may perform aspects of the described functions using special-purpose hardware.

At 1705, the method may include receiving a control message indicative of a content configuration for a MIB message, a PCI, or both, where the content configuration includes an indication of a type of information specified by one or more wildcard bits of the MIB message, the PCI, or both. The operations of 1705 may be performed in accordance with examples as disclosed herein. In some examples, aspects of the operations of 1705 may be performed by a content configuration processing component 1425 as described with reference to FIG. 14.

At 1710, the method may include receiving the MIB message, the PCI, or both, including one or more wildcard bits. The operations of 1710 may be performed in accordance with examples as disclosed herein. In some examples, aspects of the operations of 1710 may be performed by an information signaling component 1430 as described with reference to FIG. 14.

At 1715, the method may include communicating with a network entity in accordance with the type of information indicated by the one or more wildcard bits of the MIB message, the PCI, or both. The operations of 1715 may be performed in accordance with examples as disclosed herein. In some examples, aspects of the operations of 1715 may be performed by an information signaling component 1430 as described with reference to FIG. 14.

The following provides an overview of aspects of the present disclosure:

Aspect 1: A method for wireless communications at a network entity, comprising: obtaining a control message indicative of a content configuration for a MIB message, a PCI, or both, wherein the content configuration comprises an indication of a type of information to be specified by one or more wildcard bits of the MIB message, the PCI, or both; outputting the MIB message, the PCI, or both, comprising the one or more wildcard bits indicating the type of information; and communicating with a UE in accordance with the type of information indicated by the one or more wildcard bits of the MIB message, the PCI, or both.

Aspect 2: The method of aspect 1, wherein the type of information specified by the one or more wildcard bits of the MIB message, the PCI, or both, is based at least in part on an operator associated with the network entity, a geo-location of the network entity, a cell of the network entity, or any combination thereof.

Aspect 3: The method of any of aspects 1 through 2, wherein obtaining the control message indicative of the content configuration for the MIB message, the PCI, or both, comprises: obtaining an indication of a location reserved for the one or more wildcard bits in the MIB message, the PCI, or both.

Aspect 4: The method of any of aspects 1 through 3, wherein outputting the MIB message, the PCI, or both, comprises: outputting the MIB message, the PCI, or both, wherein at least one wildcard bit of the one or more wildcard bits is indicative of a mobile cell associated with the network entity, a stationary cell associated with the network entity, one or more network energy saving configurations associated with the network entity, a capability to support reduced capability UEs, one or more information elements of a SIB, or any combination thereof.

Aspect 5: The method of any of aspects 1 through 4, further comprising: outputting an indication of a communication configuration associated with the UE, wherein an application of the communication configuration is based at least in part on an application indication included in the one or more wildcard bits.

Aspect 6: The method of any of aspects 1 through 5, wherein outputting the MIB message, the PCI, or both, comprises: outputting an indication that a quantity of the one or more wildcard bits comprise fixed bits indicative of whether the one or more wildcard bits are activated or deactivated.

Aspect 7: The method of any of aspects 1 through 6, wherein obtaining the control message indicative of the content configuration for the MIB message comprises: obtaining an indication that at least a subset of wildcard bits of the one or more wildcard bits are changed from wildcard bits to one or more standardized information elements of the MIB message.

Aspect 8: The method of any of aspects 1 through 7, further comprising: outputting, to the UE, an indication of an interpretation of the type of information of the one or more wildcard bits, wherein the control message comprises a dynamically signaled message, a RRC message, a policy message, a SIB message, dedicated signaling, an information message that indicate the type of information stored in a cloud environment, or any combination thereof.

Aspect 9: The method of any of aspects 1 through 8, wherein the control message indicative of the content configuration for the MIB message, the PCI, or both, comprises an indication of a validity duration for the type of information specified by the one or more wildcard bits.

Aspect 10: The method of any of aspects 1 through 9, further comprising: receiving, from the UE, a measurement report indicative of an interpretation of the one or more wildcard bits by the UE.

Aspect 11: The method of any of aspects 1 through 10, wherein the one or more wildcard bits included in the PCI comprise one or more most significant bits or one or more least significant bits, and are indicative of a functionality or a characteristic of a cell associated with the network entity.

Aspect 12: The method of any of aspects 1 through 11, wherein obtaining the control message indicative of the content configuration for the PCI comprises: obtaining the control message including an indication of a location of the one or more wildcard bits within a bitstring of the PCI, wherein the one or more wildcard bits indicate system information.

Aspect 13: The method of any of aspects 1 through 12, wherein obtaining the control message indicative of the content configuration for the MIB message, the PCI, or both, comprises: obtain the control message via signaling between one or more network interfaces associated with the network entity, the one or more network interfaces comprising a centralized unit to distributed unit F1 interface, a centralized unit to centralized unit Xn interface, a core network interface, or any combination thereof.

Aspect 14: The method of any of aspects 1 through 13, wherein outputting the MIB message, the PCI, or both, comprises: outputting the MIB message, the PCI, or both, including an indication of system information for initial access to a cell associated with the network entity.

Aspect 15: A method for wireless communications at a UE, comprising: receiving a control message indicative of a content configuration for a MIB message, a PCI, or both, wherein the content configuration comprises an indication of a type of information specified by one or more wildcard bits of the MIB message, the PCI, or both; receiving the MIB message, the PCI, or both, comprising one or more wildcard bits; and communicating with a network entity in accordance with the type of information indicated by the one or more wildcard bits of the MIB message, the PCI, or both.

Aspect 16: The method of aspect 15, wherein receiving the control message indicative of the content configuration for the MIB message, the PCI, or both, comprises: receiving an indication of a location reserved for the one or more wildcard bits in the MIB message, the PCI, or both.

Aspect 17: The method of any of aspects 15 through 16, wherein receiving the MIB message, the PCI, or both, comprises: receiving the MIB message, the PCI, or both, wherein at least one wildcard bit of the one or more wildcard bits is indicative of a mobile cell associated with the network entity, a stationary cell associated with the network entity, one or more network energy saving configurations associated with the network entity, a capability to support reduced capability UEs, one or more information elements of a SIB, or any combination thereof.

Aspect 18: The method of any of aspects 15 through 17, further comprising: receiving an indication of a communication configuration associated with the UE, wherein an application of the communication configuration is based at least in part on an application indication included in the one or more wildcard bits.

Aspect 19: The method of any of aspects 15 through 18, wherein receiving the MIB message, the PCI, or both, comprises: receiving an indication that a quantity of the one or more wildcard bits comprise fixed bits indicative of whether the one or more wildcard bits are activated or deactivated.

Aspect 20: The method of any of aspects 15 through 19, further comprising: receiving an indication of an interpretation of the type of information of the one or more wildcard bits, wherein the control message comprises a dynamically signaled message, a RRC message, a policy message, a SIB message, dedicated signaling, an information message that indicate the type of information stored in a cloud environment, or any combination thereof.

Aspect 21: The method of any of aspects 15 through 20, wherein the control message indicative of the content configuration for the MIB message, the PCI, or both, comprises an indication of a validity duration for the type of information specified by the one or more wildcard bits.

Aspect 22: The method of any of aspects 15 through 21, further comprising: transmitting a measurement report indicative of an interpretation of the one or more wildcard bits by the UE.

Aspect 23: The method of any of aspects 15 through 22, wherein the one or more wildcard bits included in the PCI comprise one or more most significant bits or one or more least significant bits, and are indicative of a functionality or a characteristic of a cell associated with the network entity.

Aspect 24: The method of any of aspects 15 through 23, wherein receiving the control message indicative of the content configuration for the PCI comprises: receiving the control message including an indication of a location of the one or more wildcard bits within a bitstring of the PCI, wherein the one or more wildcard bits indicate system information.

Aspect 25: The method of aspect 24, further comprising: determining a structure of the PCI including the location of the one or more wildcard bits within the bitstring of the PCI based at least in part on the structure of the PCI received during a previous connection with the network entity, based at least in part on the structure of other physical cell identities received during communication with one or more other network entities, or both.

Aspect 26: The method of any of aspects 24 through 25, further comprising: determining a structure of the PCI including the location of the one or more wildcard bits within the bitstring of the PCI based at least in part on hard coded information at the UE.

Aspect 27: The method of any of aspects 15 through 26, wherein the type of information comprises system information that is indicated at least in part by the PCI, a physical broadcast channel, the MIB message, one or more DMRSs, or any combination thereof.

Aspect 28: The method of any of aspects 15 through 27, wherein receiving the MIB message, the PCI, or both, comprises: receiving the MIB message, the PCI, or both, including an indication of system information for initial access to a cell associated with the network entity; and performing an initial access procedure based at least in part on the indication of system information.

Aspect 29: A network entity for wireless communications, comprising one or more memories storing processor-executable code, and one or more processors coupled with the one or more memories and individually or collectively operable to execute the code to cause the network entity to perform a method of any of aspects 1 through 14.

Aspect 30: A network entity for wireless communications, comprising at least one means for performing a method of any of aspects 1 through 14.

Aspect 31: A non-transitory computer-readable medium storing code for wireless communications, the code comprising instructions executable by one or more processors to perform a method of any of aspects 1 through 14.

Aspect 32: A UE for wireless communications, comprising one or more memories storing processor-executable code, and one or more processors coupled with the one or more memories and individually or collectively operable to execute the code to cause the UE to perform a method of any of aspects 15 through 28.

Aspect 33: A UE for wireless communications, comprising at least one means for performing a method of any of aspects 15 through 28.

Aspect 34: A non-transitory computer-readable medium storing code for wireless communications, the code comprising instructions executable by one or more processors to perform a method of any of aspects 15 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
obtain a control message indicative of a content configuration for a master information block message, a physical cell identity, or both, wherein the content configuration comprises an indication of a type of information to be specified by one or more wildcard bits of the master information block message, the physical cell identity, or both;
output the master information block message, the physical cell identity, or both, comprising the one or more wildcard bits indicating the type of information; and
communicate with a user equipment (UE) in accordance with the type of information indicated by the one or more wildcard bits of the master information block message, the physical cell identity, or both.

2. The network entity of claim 1, wherein the type of information specified by the one or more wildcard bits of the master information block message, the physical cell identity, or both, is based at least in part on an operator associated with the network entity, a geo-location of the network entity, a cell of the network entity, or any combination thereof.

3. The network entity of claim 1, wherein, to obtain the control message indicative of the content configuration for the master information block message, the physical cell identity, or both, the one or more processors are individually or collectively operable to execute the code to cause the network entity to:
obtain an indication of a location reserved for the one or more wildcard bits in the master information block message, the physical cell identity, or both.

4. The network entity of claim 1, wherein, to output the master information block message, the physical cell identity, or both, the one or more processors are individually or collectively operable to execute the code to cause the network entity to:
output the master information block message, the physical cell identity, or both, wherein at least one wildcard bit of the one or more wildcard bits is indicative of a mobile cell associated with the network entity, a stationary cell associated with the network entity, one or more network energy saving configurations associated with the network entity, a capability to support reduced capability UEs, one or more information elements of a system information block, or any combination thereof.

5. The network entity of claim 1, wherein the one or more processors are individually or collectively further operable to execute the code to cause the network entity to:
output an indication of a communication configuration associated with the UE, wherein an application of the communication configuration is based at least in part on an application indication included in the one or more wildcard bits.

6. The network entity of claim 1, wherein, to output the master information block message, the physical cell identity, or both, the one or more processors are individually or collectively operable to execute the code to cause the network entity to:
output an indication that a quantity of the one or more wildcard bits comprise fixed bits indicative of whether the one or more wildcard bits are activated or deactivated.

7. The network entity of claim 1, wherein, to obtain the control message indicative of the content configuration for the master information block message, the one or more processors are individually or collectively operable to execute the code to cause the network entity to:
obtain an indication that at least a subset of wildcard bits of the one or more wildcard bits are changed from wildcard bits to one or more standardized information elements of the master information block message.

8. The network entity of claim 1, wherein the one or more processors are individually or collectively further operable to execute the code to cause the network entity to:
output, to the UE, an indication of an interpretation of the type of information of the one or more wildcard bits, wherein the control message comprises a dynamically signaled message, a radio resource control message, a policy message, a system information block message, dedicated signaling, an information message that indicate the type of information stored in a cloud environment, or any combination thereof.

9. The network entity of claim 1, wherein the control message indicative of the content configuration for the master information block message, the physical cell identity, or both, comprises an indication of a validity duration for the type of information specified by the one or more wildcard bits.

10. The network entity of claim 1, wherein the one or more processors are individually or collectively further operable to execute the code to cause the network entity to:
receive, from the UE, a measurement report indicative of an interpretation of the one or more wildcard bits by the UE.

11. The network entity of claim 1, wherein the one or more wildcard bits included in the physical cell identity comprise one or more most significant bits or one or more least significant bits, and are indicative of a functionality or a characteristic of a cell associated with the network entity.

12. The network entity of claim 1, wherein, to obtain the control message indicative of the content configuration for the physical cell identity, the one or more processors are individually or collectively operable to execute the code to cause the network entity to:
obtain the control message including an indication of a location of the one or more wildcard bits within a bitstring of the physical cell identity, wherein the one or more wildcard bits indicate system information.

13. The network entity of claim 1, wherein, to obtain the control message indicative of the content configuration for a master information block message, the physical cell identity, or both, the one or more processors are individually or collectively operable to execute the code to cause the network entity to:
obtain the control message via signaling between one or more network interfaces associated with the network entity, the one or more network interfaces comprising a centralized unit to distributed unit F1 interface, a centralized unit to centralized unit Xn interface, a core network interface, or any combination thereof.

14. The network entity of claim 1, wherein, to output the master information block message, the physical cell identity, or both, the one or more processors are individually or collectively operable to execute the code to cause the network entity to:
output the master information block message, the physical cell identity, or both, including an indication of system information for initial access to a cell associated with the network entity.

15. A user equipment (UE), comprising:
one or more memories storing processor-executable code; and
one or more processors coupled with the one or more memories and individually or collectively operable to execute the code to cause the UE to:
receive a control message indicative of a content configuration for a master information block message, a physical cell identity, or both, wherein the content configuration comprises an indication of a type of information specified by one or more wildcard bits of the master information block message, the physical cell identity, or both;
receive the master information block message, the physical cell identity, or both, comprising one or more wildcard bits; and
communicate with a network entity in accordance with the type of information indicated by the one or more wildcard bits of the master information block message, the physical cell identity, or both.

16. The UE of claim 15, wherein, to receive the control message indicative of the content configuration for the master information block message, the physical cell identity, or both, the one or more processors are individually or collectively operable to execute the code to cause the UE to:
receive an indication of a location reserved for the one or more wildcard bits in the master information block message, the physical cell identity, or both.

17. The UE of claim 15, wherein, to receive the control message indicative of the content configuration for the physical cell identity, the one or more processors are individually or collectively operable to execute the code to cause the UE to:
receive the control message including an indication of a location of the one or more wildcard bits within a bitstring of the physical cell identity, wherein the one or more wildcard bits indicate system information.

18. The UE of claim 17, wherein the one or more processors are individually or collectively further operable to execute the code to cause the UE to:
determine a structure of the physical cell identity including the location of the one or more wildcard bits within the bitstring of the physical cell identity based at least in part on the structure of the physical cell identity received during a previous connection with the network entity, based at least in part on the structure of other physical cell identities received during communication with one or more other network entities, or both.

19. The UE of claim 17, wherein the one or more processors are individually or collectively further operable to execute the code to cause the UE to:
determine a structure of the physical cell identity including the location of the one or more wildcard bits within the bitstring of the physical cell identity based at least in part on hard coded information at the UE.

20. A method for wireless communications at a network entity, comprising:
obtaining a control message indicative of a content configuration for a master information block message, a physical cell identity, or both, wherein the content configuration comprises an indication of a type of information to be specified by one or more wildcard bits of the master information block message, the physical cell identity, or both;
outputting the master information block message, the physical cell identity, or both, comprising the one or more wildcard bits indicating the type of information; and
communicating with a user equipment (UE) in accordance with the type of information indicated by the one or more wildcard bits of the master information block message, the physical cell identity, or both.
